(19) United States
(12) Patent Application Publication
(10) Pub. No.: US 2011/0085586 A1
(43) Pub. Date: Apr. 14, 2011

(54) TOTAL BANDWIDTH CONDITIONING DEVICE

(75) Inventors: David Kelma, Madisonville, TN (US); Tab Kendall Cox, Baldwinsville, NY (US)

(73) Assignee: John Mezzalingua Associates, Inc., East Syracuse, NY (US)

(21) Appl. No.: 12/576,612

(22) Filed: Oct. 9, 2009

(51) Int. Cl. H04B 1/38

(52) U.S. Cl. 375/219

(57) ABSTRACT

A device for conditioning a total bandwidth includes a return path extending at least a portion of a distance between a supplier side connector and a user side connector, and a forward path extending at least a portion of a distance between the supplier side connector and the user side connector. An upstream section including a variable signal level adjustment device connected within the return path. A downstream section including a forward coupler connected within the forward path. The device further includes at least one microprocessor. The microprocessor is connected electrically upstream the variable signal level adjustment device. The microprocessor reduces an amount of signal level adjustment applied to the return path in response to a reduction in a level of a downstream bandwidth at the forward coupler.

### FIELD OF THE INVENTION

The present invention relates generally to signal conditioning devices for use in community antenna television (“CATV”) systems, and in particular to signal conditioning devices that increases the signal-to-noise ratio of an upstream bandwidth in a CATV system and corrects a level and slope of a downstream bandwidth in the CATV system.

### BACKGROUND OF THE INVENTION

The use of a CATV system to provide internet, voice over internet protocol (“VOIP”) telephone, television, security, and music services is well known in the art. In providing these services, a downstream bandwidth (i.e., radio frequency (“RF”) signals, digital signals, and/or optical signals) is passed from a supplier of the services to a user, and an upstream bandwidth (i.e., radio frequency (“RF”) signals, digital signals, and/or optical signals) is passed from the user to the supplier. For much of the distance between the supplier and the user, the downstream bandwidth and the upstream bandwidth make up a total bandwidth that is passed via a signal transmission line, such as a coaxial cable. The downstream bandwidth is, for example, signals that are relatively higher in frequency within the total bandwidth of the CATV system while the upstream bandwidth is, for example, signals that are relatively lower in frequency.

Traditionally, the CATV system includes a head end facility, where the downstream bandwidth is initiated into a main CATV distribution system, which typically includes a plurality of trunk lines, each serving at least one local distribution network. In turn, the downstream bandwidth is passed to a relatively small number (e.g., approximately 100 to 500) of users associated with a particular local distribution network. Devices, such as high-pass filters, are positioned at various points within the CATV system to ensure the orderly flow of downstream bandwidth from the head end facility, through the trunk lines, through the local distribution networks, and ultimately to the users.

At various locations between the head end facility and the user, there are amplifiers and slope adjustment devices for the purpose of maintaining the quality of the downstream bandwidth. This statement introduces three terms (i.e., quality, amplifiers, and slope adjustment devices) that are important to the remaining discussion. These will be discussed broadly below.

The quality of the downstream bandwidth is often a measure of: (i) a signal level of a particular channel within the downstream bandwidth, the signal level referred to merely as “level;” and (ii) a general consistency of levels across all of the channels in the downstream bandwidth, the general consistency referred to as “slope.” These objective measurements are often used by technicians to evaluate CATV system performance during operation and to troubleshoot customer complaints.

The level of each channel should fall within a specific range that has been determined to provide satisfactory video, sound and information transfer rates for users. The specific requirements for each channel are not of importance to the present discussion, but it is helpful to understand that are specific targets for the level of each channel Note that this is a simplistic definition to explain “level,” and note that this definition does not include other variances such as between analog and digital.

Slope is measurement used to assess the amount of loss experienced due in large part to cable length. While all channels experience some loss, channels transmitted using higher frequencies within the downstream bandwidth experience more loss than those transmitted using lower frequencies. Accordingly, when the levels for all of the channels within the downstream bandwidth are graphed such that they are arranged in order according to the frequency of the channel, there may be a significant visual downward slope in the graph from the lowest frequency channel to highest frequency channel. This downward slope becomes more prominent as the length of signal cable increases. Note that this is a simplistic definition to explain the consistency of levels across all of the channels and the “slope” that is created by losses occurring in the signal cables. Also note that this definition does not include other variances such as between analog and digital.

The presence of slope is not removed through the use of typical drop-style amplifiers. The drop-style amplifiers merely amplify the entire downstream bandwidth. In other words, these drop-style amplifiers raise the level of each channel equally. In turn, if there is a large amount of slope present, such as when a user's premise includes long distances of signal cable, the drop-style amplifier may cause some channels to exceed their level specification while other channels may remain below their specification.

It is known to add a fixed or manually adjustable slope compensator/low frequency attenuator when there is a long run of signal cable. However, these devices require expensive testing equipment to determine whether and/or how much slope compensation should be supplied to a particular premise. Further, due to the cost of installation and a general misunderstanding regarding how to install such devices, there are relatively few in existence, compared to the number of such devices needed. In addition to these problems with experienced with the downstream bandwidth, the upstream bandwidth must also be conditioned to ensure customer satisfaction.

The upstream bandwidth passes through each of the local distribution networks is a compilation of an upstream bandwidth generated within a premise of each user that is connected to the particular distribution network. The upstream bandwidth generated within each premise includes desirable upstream information signals from a modem, desirable upstream information signals from a set-top-box, other desirable signals, and undesirable interference signals, such as noise or other spurious signals. Many generators of such undesirable interference signals are electrical devices that inadvertently generate electrical signals as a result of their operation. These devices include vacuum cleaners, electric motors, household transformers, welders, and many other household electrical devices. Many other generators of such undesirable interference signals include devices that intentionally create RF signals as part of their operation. These devices include wireless home telephones, cellular telephones, wireless internet devices, citizens band (“CB”) radios, personal communication devices, etc. While the RF signals generated by these latter devices are desirable for their intended purposes, these signals will conflict with the desirable upstream information signals if they are allowed to enter the CATV system.

Undesirable interference signals, whether they are inadvertently generated electrical signals or intentionally created RF signals, may be allowed to enter the CATV system, typically through an unterminated port, an improperly functioning device, a damaged coaxial cable, and/or a damaged splitter. As mentioned above, the downstream/upstream bandwidth is passed through coaxial cables for most of the distance between the user and the head end. This coaxial cable is intentionally shielded from undesirable interference signals by a conductive layer positioned radially outward from a center conductor and positioned coaxially with the center conductor. Similarly, devices connected to the coaxial cable typically provide shielding from undesirable interference signals. However, when there is no coaxial cable or no device connected to a port the center conductor is exposed to any undesirable interference signals and will function like a small antenna to gather those undesirable interference signals. Similarly, a coaxial cable or device having damaged or malfunctioning shielding may also gather undesirable interference signals.

In light of the forgoing, it should be clear that there is an inherent, system-wide flaw that leaves the upstream bandwidth open and easily impacted by any single user. For example, while the downstream bandwidth is constantly monitored and serviced by skilled network engineers, the upstream bandwidth is maintained by the user without the skill or knowledge required to reduce the creation and passage of interference signals into the upstream bandwidth. This issue is further compounded by the number of users connected together within a particular distribution network, especially knowing that one user can easily impact all of the other users.

Attempts at improving an overall signal quality of the upstream bandwidth have not been successful using traditional methods. A measure of the overall signal quality includes such components as signal strength and signal-to-noise ratio (i.e., a ratio of the desirable information signals to undesirable interference signals). Traditionally, increasing the strength of the downstream bandwidth has been accomplished by drop amplifiers employed in or near a particular user's premise. The success of these drop amplifiers is largely due to the fact that there are very low levels of undesirable interference signals present in the downstream bandwidth for the reasons explained more fully above. The inherent presence of the undesirable interference signals in the upstream bandwidth generated by each user has typically precluded the use of these typical, drop amplifiers to amplify the upstream bandwidth, because the undesirable interference signals are amplified by the same amount as the desirable information signals. Accordingly, the signal-to-noise ratio remains nearly constant, or worse, such that the overall signal quality of the upstream bandwidth is not increased when such a typical, drop amplifier is implemented.

For at least the forgoing reasons, a need is apparent for a device, which can increase the overall quality of the downstream bandwidth and the upstream bandwidth at the same time.

### SUMMARY OF THE INVENTION

The present invention helps to reduce the effect of undesirable interference signals that are unknowingly injected into the main signal distribution system, through the upstream bandwidth, by a user.

In accordance with one embodiment of the present invention, a device is provided for conditioning a total bandwidth. The device includes a return path extending at least a portion of a distance between a supplier side connector and a user side connector, and a forward path extending at least a portion of a distance between the supplier side connector and the user side connector. An upstream section including a variable signal level adjustment device connected within the return path. A downstream section including a forward coupler connected within the forward path. The device further includes at least one microprocessor. The microprocessor is connected electrically upstream the variable signal level adjustment device. The microprocessor reduces an amount of signal level adjustment applied to the return path in response to a reduction in a level of a downstream bandwidth at the forward coupler.

In accordance with one embodiment of the present invention, a method is provided for conditioning an upstream bandwidth. The method includes adding at least one increment of attenuation to the upstream bandwidth. The method further includes measuring a first level of the downstream bandwidth. The method further includes removing at least a portion of the at least one increment of attenuation in response to the first level of the downstream bandwidth.

### BRIEF DESCRIPTION OF THE DRAWINGS

For a further understanding of the nature and objects of the invention, references should be made to the following detailed description of a preferred mode of practicing the invention, read in connection with the accompanying drawings in which:

FIG. 1 is a graphical representation of a CATV system arranged in accordance with an embodiment of the present invention;

FIG. 2 is a graphical representation of a user's premise arranged in accordance with an embodiment of the present invention;

FIG. 3 is a circuit diagram representing a conditioning device including an upstream section and a downstream section made in accordance with one embodiment of the present invention, the downstream section is represented in dashed lines to add clarity to the upstream section, the downstream section being represented in FIG. 15;

FIG. 4 is a circuit diagram representing a coupler used in a conditioning device made in accordance with one embodiment of the present invention;

FIG. 5 is a circuit diagram representing a high pass filter used in a conditioning device made in accordance with one embodiment of the present invention;

FIG. 6 is a circuit diagram representing a RF detection circuit used in a conditioning device made in accordance with one embodiment of the present invention;

FIG. 7 is a circuit diagram representing a level detector used in a conditioning device made in accordance with one embodiment of the present invention;

FIG. 8 is a graphical representation of a voltage stream passing from a RF detector to a low-pass amplifier within a RF detection circuit used in a conditioning device made in accordance with one embodiment of the present invention;

FIG. 9 is a graphical representation of a voltage stream passing from a low-pass amplifier within a RF detection circuit to a level detector used in a conditioning device made in accordance with one embodiment of the present invention;

FIG. 10 is a graphical representation of a voltage stream passing from a level detector to a non-linear amplifier used in a premise device made in accordance with one embodiment of the present invention;

FIG. 11 is a circuit diagram of a non-linear amplifier used in a conditioning device made in accordance with one embodiment of the present invention;

FIG. 12 is a graphical representation of a theoretical response of a non-linear amplifier in response to a linearly increasing voltage;

FIG. 13 is a graphical representation of a voltage stream passing from a non-linear amplifier to a microprocessor used in a conditioning device made in accordance with one embodiment of the present invention;

FIG. 14 is a flow chart representing a level measurement routine performed by a microprocessor used in a conditioning device made in accordance with one embodiment of the present invention.

FIG. 15 is a circuit diagram representing the conditioning device of FIG. 3 with the upstream section represented in dashed lines to add clarity to the downstream section shown as made in accordance with one embodiment of the present invention;

FIG. 16 is a flow chart representing a signal level measurement routine performed by a microprocessor used in a conditioning device made in accordance with one embodiment of the present invention.

FIG. 17 is a flow chart representing a signal level measurement routine performed by a microprocessor used in a conditioning device made in accordance with one embodiment of the present invention;

FIG. 18 is a graph representative of a level curve of a downstream bandwidth prior to a level adjustment and a slope adjustment;

FIG. 19 is a graph representative of a level curve of a downstream bandwidth after a level adjustment and before a slope adjustment;

FIG. 20 is a graph representative of a level curve of a downstream bandwidth after a level adjustment and after a slope adjustment, the slope adjustment resulting in a constant 12 dBmV level curve;

FIG. 21 is a graph representative of a level curve of a downstream bandwidth after a level adjustment and after a slope adjustment, the slope adjustment resulting in an upward slope of 2 dBmV between 54 MHz and 1000 MHz.

FIG. 22 is a flow chart representing a attenuation reduction routine performed by a microprocessor used in a conditioning device made in accordance with one embodiment of the present invention.

### DETAILED DESCRIPTION OF THE INVENTION

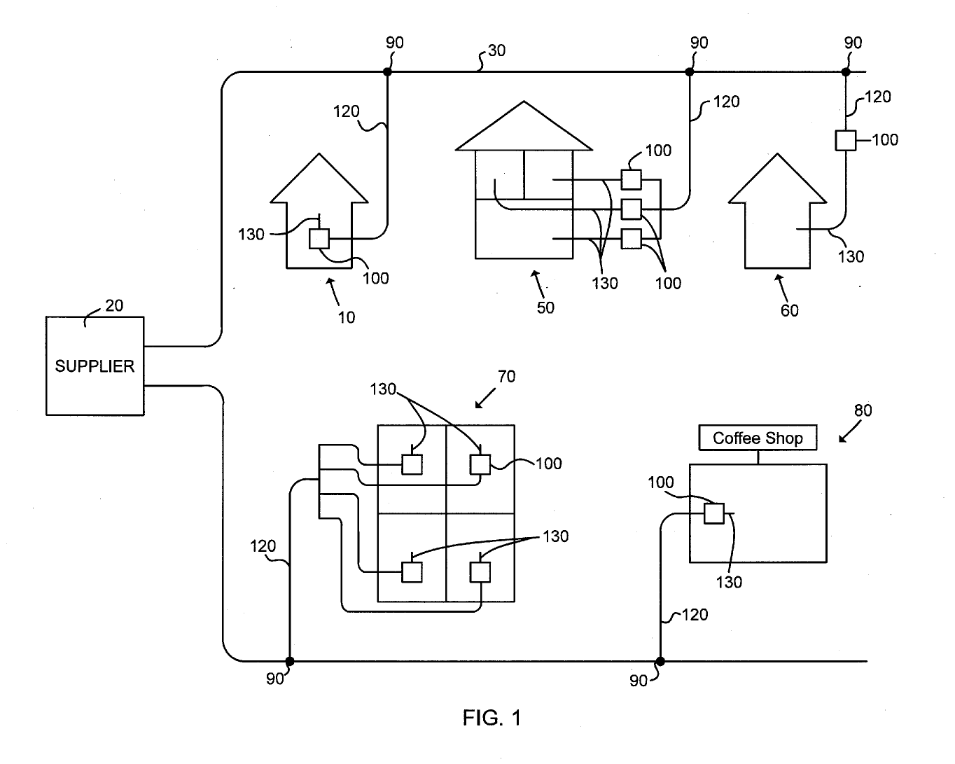

As shown in FIG. 1, a CATV system typically includes a supplier 20 that transmits a downstream bandwidth, such as RF signals, digital signals, and/or optical signals, to a user through a main distribution system 30 and receives an upstream bandwidth, such as RF signals, digital signals, and/or optical signals, from a user through the same main signal distribution system 30. A tap 90 is located at the main signal distribution system 30 to allow for the passage of the downstream/upstream bandwidth from/to the main signal distribution system 30. A drop transmission line 120 is then used to connect the tap 90 to a house 10, 60 an apartment building 50, 70, a coffee shop 80, and so on. As shown in FIG. 1, a total bandwidth conditioning device 100 (“conditioning device 100”) of the present invention may be connected in series between the drop transmission line 120 and a user's premise distribution system 130.

Referring still to FIG. 1, it should be understood that the conditioning device 100 can be placed at any location between the tap 90 and the user's premise distribution system 130. This location can be conveniently positioned within the premise (e.g., the house 10, the apartment building 70, etc.), or proximate to the premise (e.g., the house 60, the apartment building 50, etc.). It should be understood that the conditioning device 100 can be placed at any location, such as the coffee shop 80 or other business, where CATV services, including internet services, VOIP services, or other unidirectional/bidirectional services are being used.

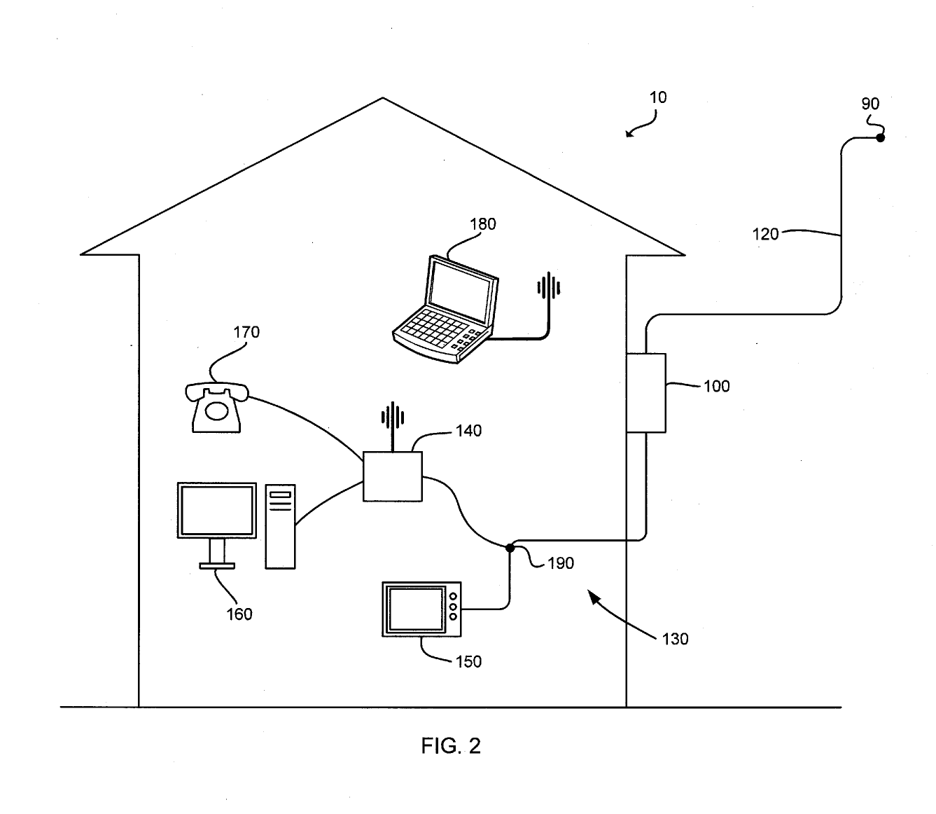

As shown in FIG. 2, the user's premise distribution system 130 may be split using a splitter 190 so that downstream/upstream bandwidth can pass to/from a television 150 and a modem 140 in accordance with practices well known in the art. The modem 140 may include VOIP capabilities affording telephone 170 services and may include a router affording internet services to a desktop computer 160 and a laptop computer 180, for example.

Additionally, it is common practice to provide a set-top box (“STB”) or a set-top unit (“STU”) for use directly with the television 150. For the sake of clarity, however, there is no representation of a STB or a STU included in FIG. 2. The STB and STU are mentioned here in light of the fact that many models utilize the upstream bandwidth to transmit information relating to “pay-per-view” purchases, billing, utilization, and other user interactions, all of which may require information to be sent from the STB or STU to the supplier 20. Accordingly, it should be understood that even though FIG. 2 explicitly shows that there is only one conditioning device 100 used for one premise device (i.e., the modem 140), each conditioning device 100 may be used with two or more premise devices (e.g., a modem, a STB, a STU, and/or a dedicated VOIP server) that transmit desirable upstream information signals via the upstream bandwidth.

The term “premise device” is used throughout to describe any one or more of a variety of devices that generate desirable portions of an upstream bandwidth. More specifically, the term premise device is used to describe devices located on or proximate to a user's premise that either receive the downstream bandwidth, transmit information toward the supplier 20 via the upstream bandwidth, or both. These premise devices include internet access modems, STBs, STUs, televisions, premise security monitoring devices, and any future devices that may have a need to report or otherwise provide information via the upstream bandwidth.

Further, while not shown explicitly in FIG. 2, there may be two (or more) conditioning devices 100 located within or proximate to a single premise. For example, there may be a conditioning device 100 located between the modem 140 and the splitter 190 and another conditioning device 100 located between an STB or STU on the television 150 and the splitter 190. Similarly, there may be a conditioning device 100 located at any point in the premise distribution system 130 where an upstream bandwidth is being passed (e.g., from a modem, a STB, a STU, a VOIP server, etc.).

Further, while not shown explicitly in FIG. 2, there may by one conditioning device 100 located proximate to two user premises when there is one drop transmission line 120 used to connect the tap 90 to both of the two user premises. Even though such an arrangement is not considered ideal, because the upstream bandwidth from two users may be merged prior to being conditioned, such an arrangement may be necessary when the two premises are located too closely to one another for the physical placement of separate conditioning devices 100.

It should be understood that the goal of placing the conditioning device 100 into one of the locations described above is to increase the overall quality of the upstream bandwidth in the main distribution system 30 by increasing the signal-to-noise ratio of the upstream bandwidth leaving the user's premise before that particular user's upstream bandwidth is merged with those of other users. As discussed above, merely amplifying the upstream bandwidth fails to achieve the desired result because the undesirable interference signals present in the upstream bandwidth are also amplified.

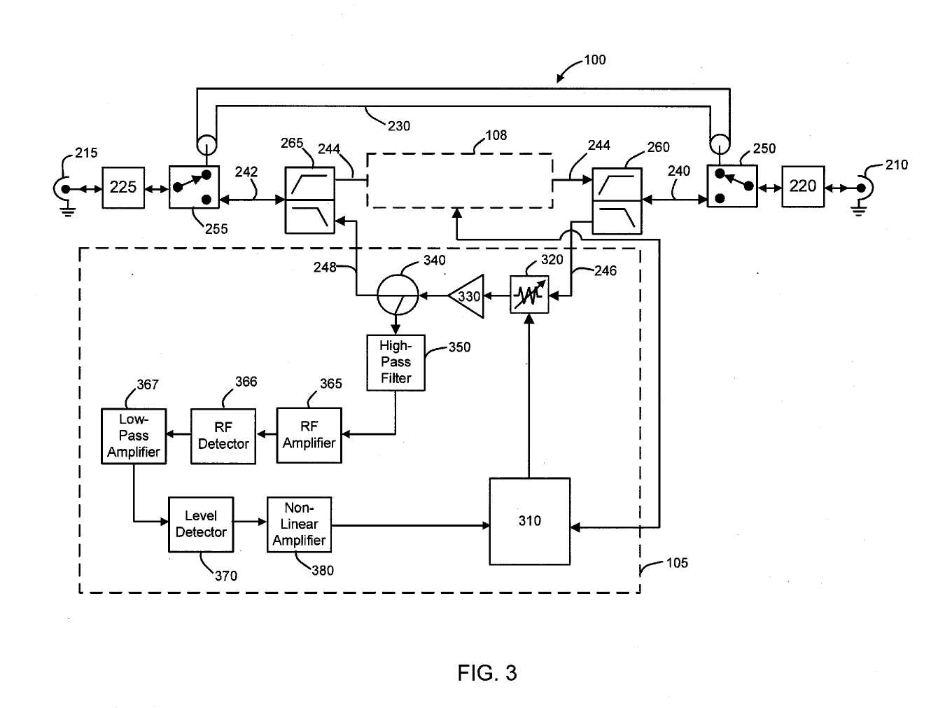

Referring now to FIG. 3, the description of the conditioning device 100 will be broken down into four general topics of discussion: (i) general components; (ii) an upstream section 105; (iii) a downstream section 108; and (iv) interactions between the upstream section 105 and the downstream section 108. The general components will be discussed first to develop the terminology used throughout and to help explain how the upstream bandwidth is passed to the upstream section 105 and how the downstream bandwidth is passed to the downstream section 108. Each of the upstream section 105 and the downstream section 108 will be discussed in terms of hardware, operation, and control.

### (i) General Components

Referring still to FIG. 3, the conditioning device 100 may include a user side connector 210 and a supplier side connector 215. Each of these connectors 210, 215 may be any of the connectors used in the art for connecting a signal cable to a device. For example, each of the user side connector 210 and the supplier side connector 215 may be a traditional female “F-type” connector.

A user side surge protector 220 and a supplier side surge protector 225 may be provided electrically adjacent the user side connector 210 and the supplier side connector 215, respectively. This positioning of the surge protectors 220, 225 allows for the protection of electrically fragile components (discussed more fully below) positioned between the surge protectors 220, 225. Each of the user side surge protector 220 and the supplier side surge protector 225 may be any of the surge protectors known in the art for electronic applications.

A user side switch 250 and a supplier side switch 255 each have two positions. In a first, default position (shown in FIG. 3), the switches 250, 255 pass signals through a bypass path 230. In a second position, the user side switch 250 and the supplier side switch 255 electrically connect the user side connector 210 to a user side main path 240 and the supplier side connector 215 to the a supplier side main path 242, respectively. As will be discussed further below, the primary components of the conditioning device 100 are electrically connected in series between the user side main path 240 and the supplier side main path 242.

The switches 250, 255 allow the total bandwidth to pass through the bypass path 230 in the event of a fault within the conditioning device 100, such as an electrical power failure. The switches 250, 255 may be any of the SPDT (Single Pole Double Throw) switches known in the art. For example the switches 250, 255 may be selected and installed such that when there is no electrical power present to the conditioning device 100, the switches 250, 255 automatically select the first, default position to pass the total bandwidth through the bypass path 230. Conversely, when there is electrical power present, the switches 250, 255 move toward their second position passing the total bandwidth to the main paths 240, 242. In the event of an electrical short within the conditioning device 100, it is likely that the short will cause an additional current flow that will ultimately result in the destruction of a fuse or in an opening of a circuit breaker type device (not shown). Accordingly, such a short will likely result in a loss of power to switches allowing the total bandwidth to pass through the bypass path 230.

A microprocessor 310 (discussed more fully below) may also be used to actuate the switches 250, 255 to their first position (i.e., to the bypass path 230) when a fault, other than an electrical power loss, is detected within the conditioning device 100. While the circuitry for such a connection is not shown in FIG. 3, it should be understood that the control by the microprocessor 310 should be in addition to the switches 250, 255 automatic positioning due to an electrical failure.

The term “microprocessor” used throughout should be understood to include all active circuits capable of performing the functions discussed herein. For example, the microprocessor 310 may be replaced with a microcontroller, a system specific digital controller, or a complex analog circuit.

The bypass path 230 may be a coaxial cable, an unshielded wire, and/or a metallic trace on a circuit board. All of these options are capable of passing the total bandwidth with little signal attenuation.

A user side diplexer 260 and a supplier side diplexer 265 are electrically coupled to the user side main path 240 and the supplier side main path 242, respectfully. The diplexers 260, 265 are arranged and configured to create a forward path 244 and a return path 246, 248 there between. Each of the diplexers 260, 265 may function like a combination of a splitter, a high-pass filter, and a low-pass filter, the splitter dividing the respective main path 240, 242 into two signal paths, one for each of the low-pass filter and the high-pass filter. Using the terms of this combination, each of the high-pass filters passes the downstream bandwidth, and each of the low-pass filters passes the upstream bandwidth. In the present example, the downstream bandwidth passes along the forward path 244 between the diplexers 260, 265. The upstream bandwidth passes along the return path 246, 248 between the diplexers 260, 265.

### (ii) Upstream Section

In an effort to set the stage for the following discussion, the hardware, the operation, and the control of the upstream section 105 will be first described here in very general detail. The upstream section 105 selectively attenuates the upstream bandwidth in increments with the knowledge that a typical premise device will increase the power with which it transmits its portion of the upstream bandwidth (i.e., the desirable upstream bandwidth) to account for the added attenuation. The result is that the desirable upstream bandwidth will be larger in percentage than the remaining portions (i.e., the undesirable upstream bandwidth). To accomplish these goals, the upstream section 105 must be able to precisely measure the level of the desirable upstream bandwidth in order to increase the amount of attenuation without adding more attenuation than the premise device can account for in terms of increasing its output power. Precise measurements of the desirable upstream bandwidth level are difficult, if not impossible, to make using only traditional level detectors.

The desirable upstream bandwidth is difficult to measure due to the inherent functional characteristics of premise devices. For example, a premise device typically transmits a desirable upstream bandwidth only when that premise device is being requested to transmit information. For example, a premise device, such as an internet access modem, typically transmits information only when a user sends information to the internet. Because there is no way to anticipate when such information is to be sent, the desirable upstream bandwidth created by the premise device must be assumed to be time independent and time discontinuous. Further, the continuity of the information that is being transmitted varies greatly, such as between a simple Pay-Per-View purchase request and an Internet upload of a large, detailed photograph. In other words, the portion of the upstream bandwidth created by a premise device may occur at any time and may occur for any length of time. The upstream section 105 includes features that are used specifically to identify this time independent and time discontinuous desirable upstream bandwidth.

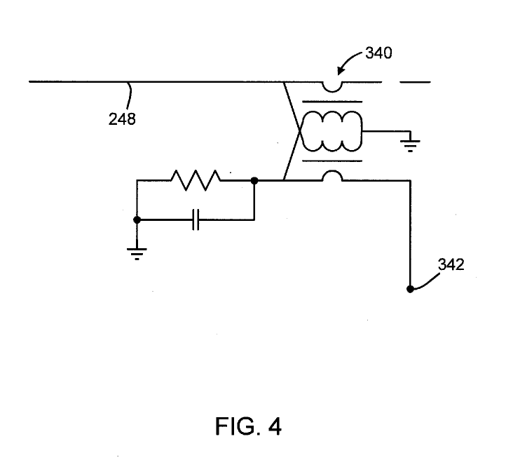

The upstream section 105 includes a coupler 340 connected within the return path 246, 248 to pass a portion of the upstream bandwidth, in terms of power and/or frequency range, to subsequent devices in the upstream section 105 via secondary path proceeding from a coupler output 342 (FIG. 4). One skilled in the art would readily understand, based on the present description and the size requirements of a particular installation, which type of coupler would be suitable for the present purpose. For example, a simple resistor, a power divider, a directional coupler, and/or a splitter may be used with careful consideration of the effects that these alternatives may have on the characteristic impedance of the conditioning device 100. Individual components present in one embodiment of the coupler 340 are represented in FIG. 4.

The term “connected” is used throughout to mean optically or electrically positioned such that current, voltages, and/or light are passed between the connected components. It should be understood that the term “connected” does not exclude the possibility of intervening components or devices between the connected components. For example, the coupler 340 is connected to a RF amplifier 365 even though a high pass filter 350 is shown to be positioned in an intervening relation between the coupler 340 and the RF amplifier.

The terms “connected electrically downstream” and “connected electrically upstream” may also be used throughout to aid in the description regarding where or how the two components are connected. As an example, when a second device is connected electrically downstream from a first device, the second device receives signal from the first device. This same arrangement could also be described as having the first device connected electrically upstream from the second device.

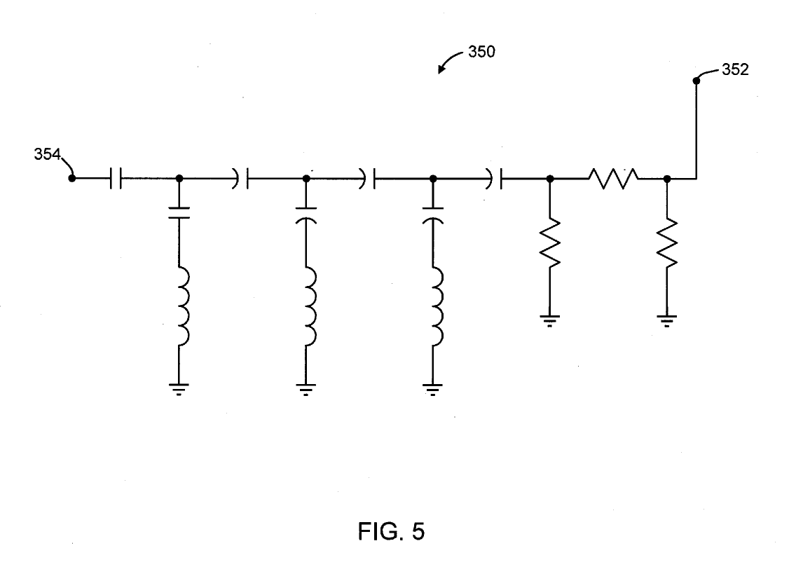

Referring back to FIG. 3, the high-pass filter 350 is connected electrically downstream from the coupler 340 such that the coupler output 342 is electrically connected to a high-pass filter input 352 (FIG. 5). The high-pass filter 350 is utilized in this instance to pass only a segment of the upstream bandwidth through to the remaining devices, discussed below, via a high-pass filter output 354 (FIG. 5). Such a high-pass filter 350 may not be required in all instances, but may be beneficial in that it attenuates segments of the upstream bandwidth that are known not to carry the desirable upstream bandwidth. For example, if the premise devices are known to provide their desirable upstream bandwidth in a specific segment of the upstream bandwidth, it may be beneficial to configure the high-pass filter 350 to attenuate segments of the upstream bandwidth below the specific segment of the upstream bandwidth where the premise device transmits. One skilled in the art would readily understand, based on the present description and the size requirements of a particular installation, which type of high-pass filter would be suitable for the present purpose. Individual components present in one embodiment of the high-pass filter 350 are represented in FIG. 5.

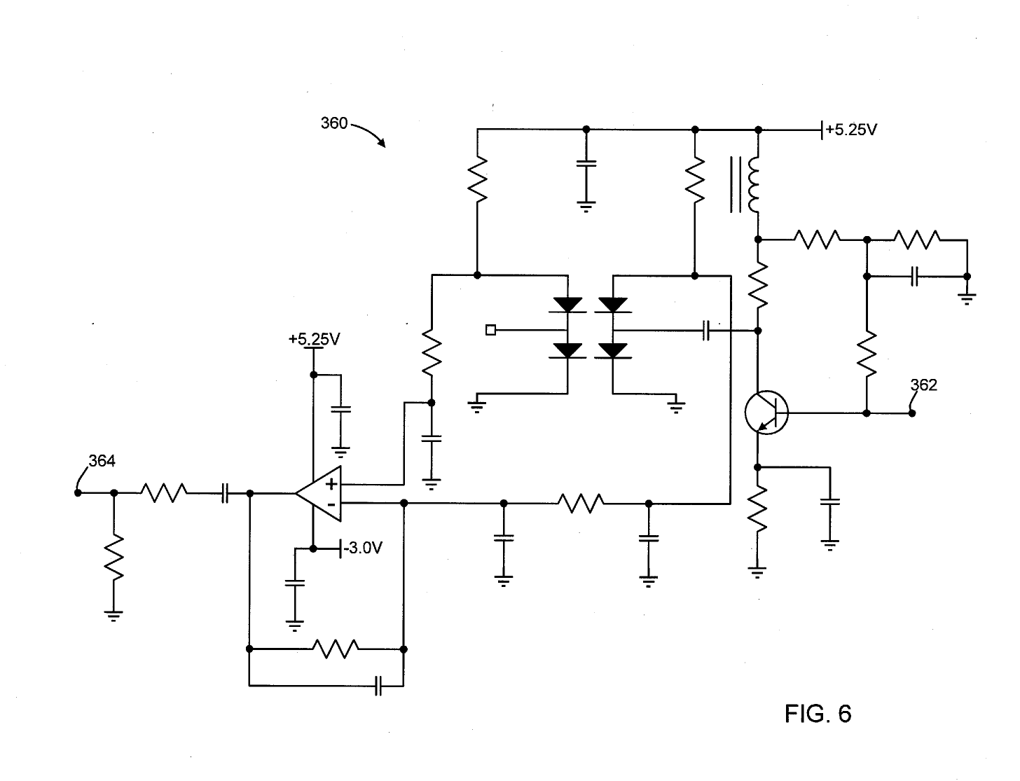

A RF detection circuit 360 is connected electrically downstream from the high-pass filter 350 such that the high-pass filter output 354 is electrically connected to a RF detector input 362 (FIG. 6). The RF detection circuit 360 includes a RF amplifier 365 a RF detector 366 and a low-pass amplifier 367. The RF amplifier 365 amplifies the portion of the downstream bandwidth passed through the high-pass filter 350 in preparation for the RF detector 366. The RF detector 366 functions as an inverse Laplace transform, the Laplace transform being a widely used intregal transform, to convert the portion of the downstream bandwidth from a frequency domain voltage stream into a time domain voltage stream. The inverse Laplace transform is given the following complex integral, which is known by various names, the Bromwich integral, the Fourier-Mellin integral, and Mellin's inverse formula. An alternative formula for the inverse Laplace transform is given by Post's inversion formula. The time domain voltage stream is then passed to the low-pass amplifier 367, which amplifies the voltages while discriminating in the time between those having suitable signal duration and those that are too short for usage within the following circuitry stages.

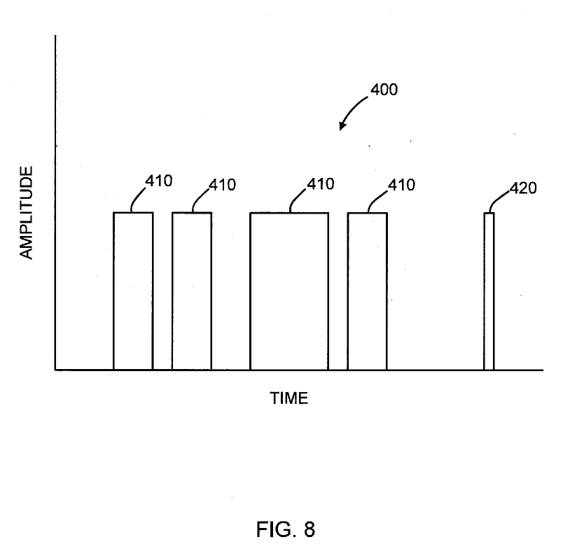

As an example, FIG. 8 represents a time domain voltage stream output 400 from the RF detector 366 to the low-pass amplifier 367. The time domain voltage stream 400 includes increased voltage levels 410 and 420 that last for varying amounts of time. Longer sections of increased voltage 410 typically represent significant information being sent by a premise device, while shorter sections of increased voltage 420 typically represent “pings,” which are very short bursts of little information. These longer sections of increased voltage have a period that may be typical for a particular premise device. In other words, the longer sections of increased voltages 410 may have shorter or longer sections of lower voltage between the longer sections of increased voltages 410. This period, which may change based on the types of premise devices present, will be important when discussing a level detector 370.

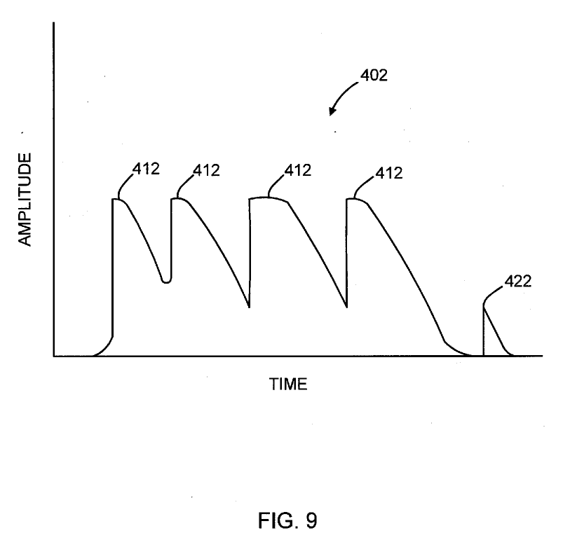

Referring now to FIG. 9, the low-pass amplifier 367 creates a voltage stream 402 where the longer periods of increased voltage 410 (FIG. 8) result in higher voltages 412 and where the shorter periods of increased voltage 420 (FIG. 8) result in lower voltages 422. This voltage stream 402 is then output to the level detector 370 from a RF detection circuit output 364. One skilled in the art would readily understand, based on the present description and the size requirements of a particular installation, which type of components should be used to create the RF detection circuit 360. Individual components present in one embodiment of the RF detection circuit 360 are represented in FIG. 6.

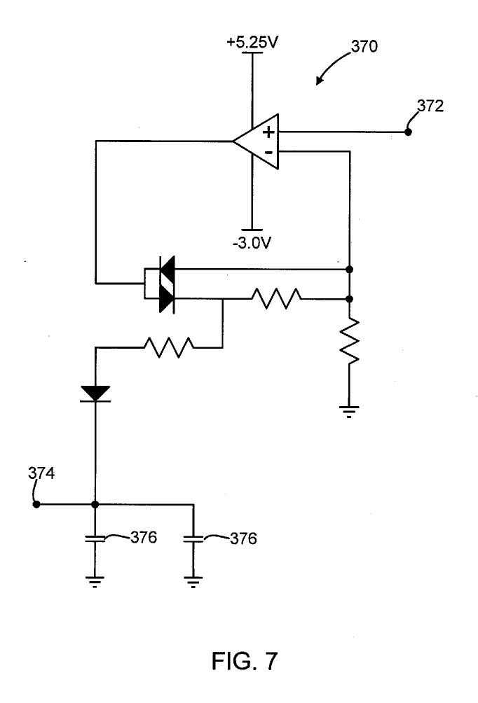

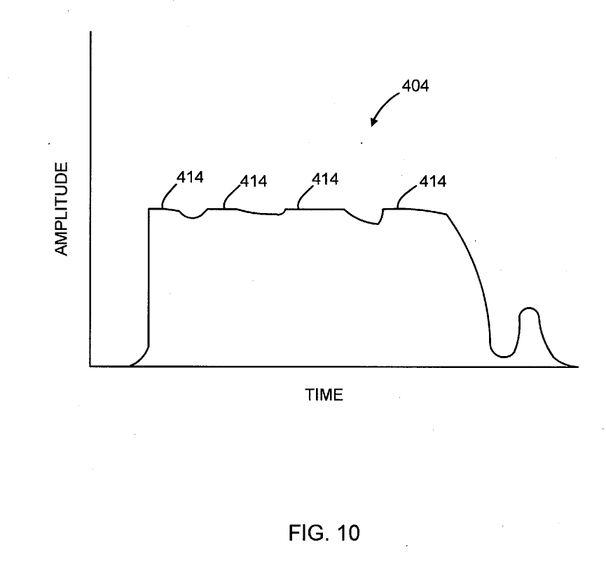

The level detector 370 is connected electrically downstream from the RF detection circuit 360 such that the output of the RF detection circuit is electrically connected to a level detector input 372 (FIG. 7). The level detector 370 generates additional current based on the voltage stream provided by the RF detection circuit 360, and the level detector 370 includes at least one diode and at least one relatively large capacitor 376 to store the current provided. A voltage stream 404 (FIG. 10) provided from the large capacitor 376 to the level detector output 374 is relative to the voltage stream 402 provided by the RF detection circuit 360 at the level detector input 372, except that any increased voltage 412, 422 is held for a duration longer than that of the voltage stream 402 from the RF detection circuit 360. The amount of duration that any increased voltage is held is strictly a factor of the sizing of the at least one capacitor, the sizing of an associated resistor, and the current drawn by subsequent devices.

Referring now to FIG. 10, the level detector 370 creates the voltage stream 404 where the longer periods of increased voltage 412 (FIG. 9) are more consistent such that there is less voltage decline between the resulting longer periods of increased voltage 414. This voltage stream 404 is then output to a non-linear amplifier 380 from a level detector output 374.

Individual components present in one embodiment of the level detector 370 are represented in FIG. 7. While most of the components are self explanatory to one skilled in the art, it is notable that the level detector 370 made in accordance with one embodiment includes two 10 μF capacitors 376 sufficient to hold a voltage for up to six seconds. This amount of time has been found to be sufficient to join message voltages 412 (FIG. 9) in the voltage stream 402 (FIG. 9) for the measurements made by the microprocessor 310, discussed more fully below. The amount of time duration may be less or more depending on the congruity of the messages typically being sent and the speed of the processor 310.

More generally speaking, the duration needed for the present embodiment is approximately ten times the period of the longer sections of increased voltage 410 provided by the premise device. Accordingly, the duration may change depending on the premise devices present. Further, it should be understood that the term approximately is used here in relation to the “ten times” multiplier because less than ten times may work well enough if a low voltage threshold (“VIL”) is reduced accordingly to allow for greater voltage drops between the longer sections of increased voltage 410. More than ten times may result in a duration that is too long, where the voltage may not drop soon enough past the VIL to properly stop a series. These statements will be understood once the VIL and its effect on a series is discussed more fully below. As would be understood by one skilled in the art based on the present description, the amount of capacitance desired for a particular amount of duration may be accomplished by one large capacitor or a plurality of smaller capacitors.

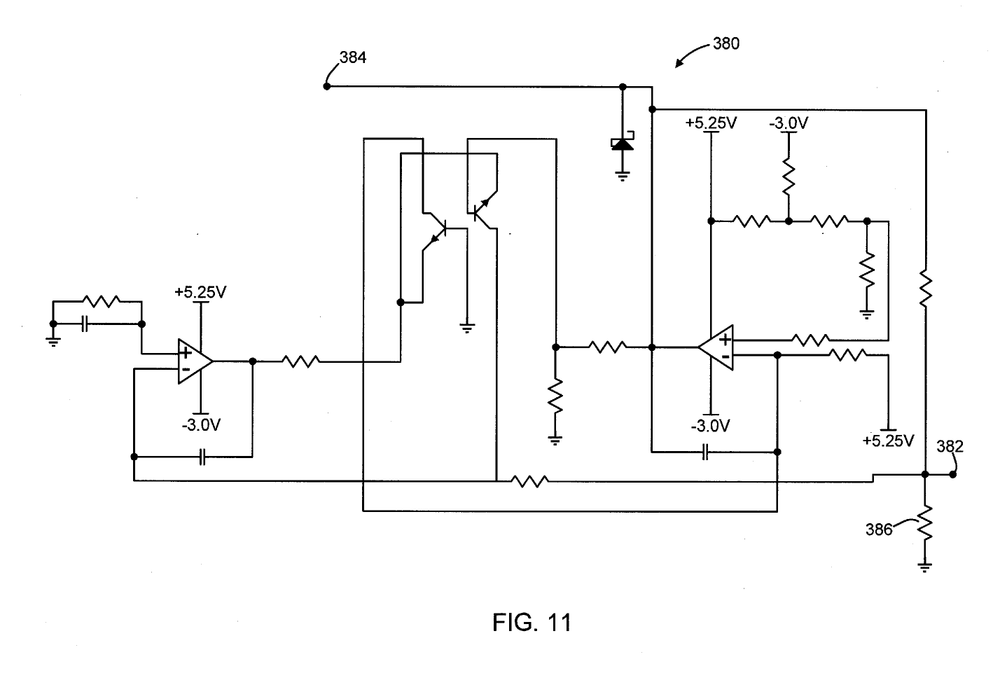

Referring back to FIG. 3, the non-linear amplifier 380 is connected electrically downstream from the level detector 370 such that the level detector output 374 is electrically connected to a non-linear amplifier input 382 (FIG. 11). The non-linear amplifier 380 compresses the voltage stream 404 provided by the level detector 370 to provide additional resolution to lower voltages. Specifically, the non-linear amplifier 380 provides additional detail to lower voltages without unnecessarily providing additional resolution to higher voltages. This is important in the present embodiment of the upstream bandwidth conditioning device because the microprocessor 310 accepts a voltage stream from the non-linear amplifier 380 at the non-linear amplifier output 384 (FIG. 11) and converts it to a digital value in the range of 0-255. Additional resolution applied to the entire voltage stream from the level detector 370 would require more than 255 digital values, and a linear resolution of the voltage stream from the level detector 370 may result in poor quality measurements of the upstream bandwidth. Individual components present in one embodiment of the non-linear amplifier 380 are represented in FIG. 11. It should be understood that when additional resolution within the microprocessor 310 is available, the non-linear amplifier 380 may not be required.

The non-linear amplifier 380 is shown in FIG. 11 to include a resistor 386 positioned near the non-linear amplifier input 382. This resistor 386 allows for the voltage stream 404 from the level detector 370 to bleed off rather than to maintain a particular voltage indefinitely. Accordingly, it should be understood that this resistor 386 may be considered to be a part of either the level detector 370 or the non-linear amplifier 380.

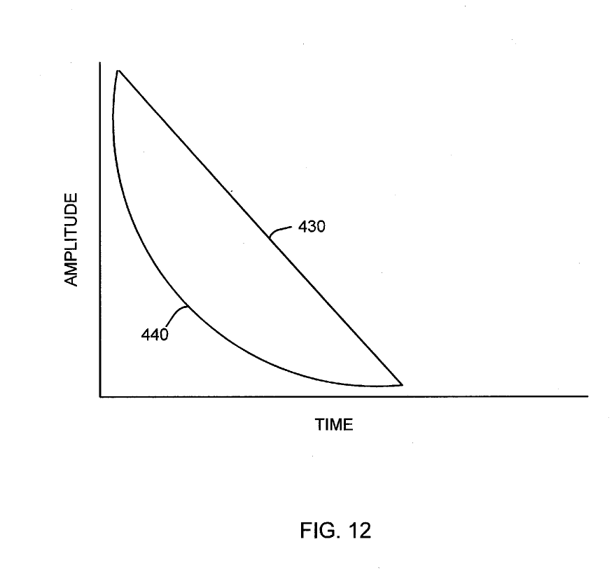

An example of a linearly changing input voltage stream 430 along with a non-linearly changing output voltage stream 440 can be seen in FIG. 12. As shown, at relatively low input voltage levels, the output voltage stream 440 changes significantly more in relation to any changes in the input voltage stream 430. However, at relatively high voltage levels, the output voltage stream 440 changes significantly less in relation to any changes in the input voltage stream 430.

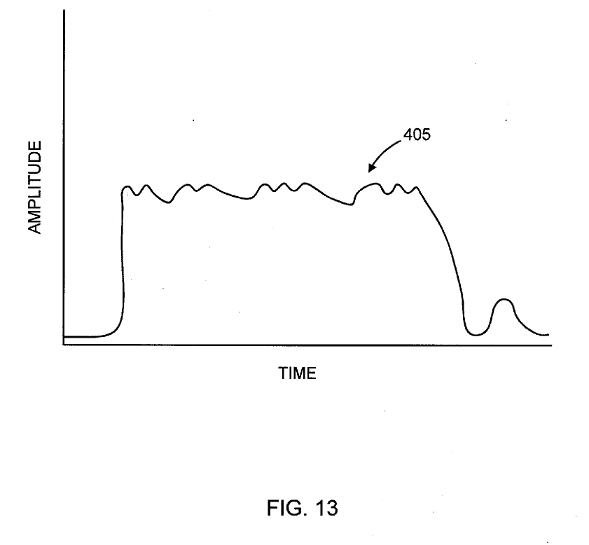

FIG. 13, represents an exemplary output voltage stream 405 produced in response to the voltage stream 404 represented in FIG. 10. As shown, the effect of the non-linear amplifier 380 is to emphasize details present in the lower voltages while deemphasizing the higher voltages. As mentioned above, this effect of the non-linear amplifier 380 helps provide additional resolution to the lower voltages for measurement purposes.

Referring again to FIG. 3, the microprocessor 310 may be electrically connected downstream from the non-linear amplifier 380 such that the microprocessor 310 is connected to the non-linear amplifier output 384. The microprocessor 310 measures the individual voltages from the non-linear amplifier 380 and may convert these voltages into a digital scale of 0-255. It should be understood that the present scale of 0-255 was chosen in the present embodiment only because of the capabilities of the microprocessor 310. Many other scales, including an actual voltage measurement may also function depending on the capabilities of the microprocessor 310. Because of these possible differences in measurement value scales, the term “level value” will be used throughout to describe the value assigned to a particular voltage input to the microprocessor 310 for further processing. Further, as mentioned above, the non-linear amplifier 380 may not be needed if the microprocessor 310 used includes greater resolution capacities than in the present embodiment.

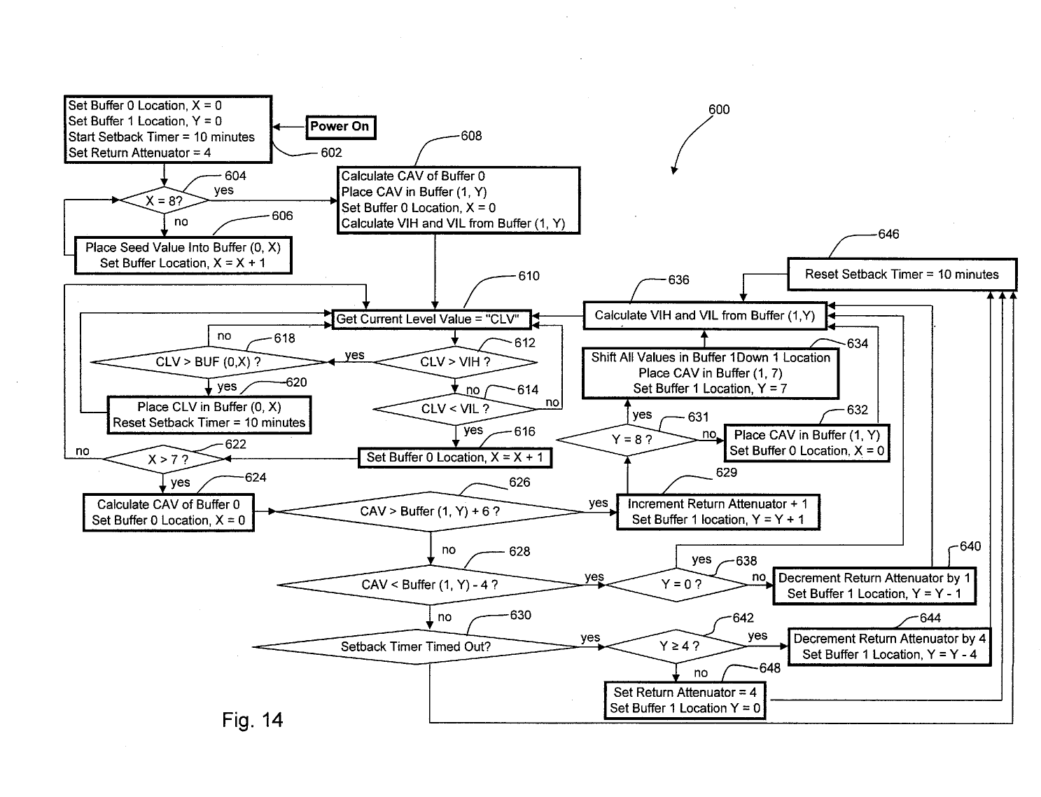

The operation and control of the upstream section 105 will now be described in detail with reference to a flow chart shown in FIG. 14. As mentioned above, the upstream section 105 may intentionally attenuate the upstream bandwidth knowing that most premise devices will automatically increase their output level to counteract the effect of the any added attenuation. Accordingly, with each amount of added attenuation, the signal-to-noise ratio of the upstream bandwidth increases because the noise is attenuated and the premise device has increased its output of desirable frequencies. The limit of this increase in signal-to-noise ratio is the amount of increase in the desirable upstream bandwidth that can be added by the premise device. Accordingly, the level of the upstream bandwidth must be checked and monitored to ensure that the amount of added attenuation does not continually exceed the amount of additional output possible by the premise device.

Referring now to FIG. 14, the microprocessor 310 works through a series of process steps 600 to determine a level value of the desirable upstream bandwidth generated by a premise device. As part of this determination, the microprocessor utilizes two buffers, a Buffer Ø and a Buffer 1.

The Buffer Ø has eight input locations (Ø-7) in the present embodiment. In the process 600, the Buffer Ø input locations, may be referred to in two separate manners. First, the Buffer Ø input locations may be referred to specifically as Buffer (Ø, Ø), Buffer (Ø, 1), Buffer (Ø, 2), Buffer (Ø, 3), Buffer (Ø, 4), Buffer (Ø, 5), Buffer (Ø, 6), and Buffer (Ø, 7). Second, the Buffer Ø input locations may be referred to as Buffer (Ø, X), where X is a variable that is increased and reset as part of the process 600. The average of the Buffer Ø input locations is referred to herein as the current average value (“CAV”).

The Buffer 1 has eight input locations (Ø-7) in the present embodiment. In the process 600, the Buffer 1 input locations may be referred to specifically as Buffer (1, Ø), Buffer (1, 1), Buffer (1, 2), Buffer (1, 3), Buffer (1, 4), Buffer (1, 5), and Buffer (1, 6) and Buffer (1, 7) Further, the Buffer 1 Input Location may be referred to as Buffer (Ø, Y), where Y is a variable that is increased, decreased, and reset as part of the process 600.

Each of the Buffer Ø and the Buffer 1 may include more or less than eight input locations. While it has been found that eight input location works well for the intended purpose of obtaining a level of the upstream bandwidth, more input locations may provide a smoother level value with less volatility. The additional input locations come at a cost of additional time to obtain a level measurement and additional processor consumption.

Upon a powering on of the conditioning device 100, the microprocessor 310 performs an initialization routine, which includes steps 602, 604, 606, and 608. According to step 602, the Buffer Ø input location X is set to Ø, and the Buffer 1 input location Y is set to Ø.

Further according to step 602, the microprocessor 310 starts a setback timer, which is set to run for ten minutes in the present embodiment. As will become more apparent during the following description, this ten minute timer is intended to release attenuation placed on the upstream bandwidth when there is no activity from a premise device sensed for the ten minutes. The term “activity” is used here to describe the presence of a CLV that is above VIH. The time of ten minutes may be shorter or longer depending on the experience of users on a particular CATV network. The ten minute time was chosen for the present embodiment in light of an assumption that most people using the internet, VOIP, and/or STB/STU will perform at least one function within a ten minute span. It is assumed that time spans longer than ten minutes typically mean that no user is currently utilizing the internet, VOIP, and/or STB/STU.

Further according to step 602, the return attenuator 320 (FIG. 3) is set to 4 dB of attenuation. This amount of attenuation is the base attenuation provided by the present embodiment of the conditioning device 100. This base amount of attenuation may be increased or decreased based on the experience of a particular CATV system. This base amount of 4 dB was chosen because it offered some amount of beneficial noise reduction, but it was low enough to not interfere with any tested premise device, when that premise device was initially turned on and was functioning normally.

According to step 604, the microprocessor 310 checks to see whether the Buffer Ø input location X is equal to 8. The purpose of step 604 is to determine whether Buffer Ø is full. The value of 8 is used, because X is incremented by one after a seed value (discussed below) is placed in the last buffer location (i.e. Buffer (Ø, 7)). Accordingly, even though there is no location “8,” the value of eight is relevant to the present determination. It should be understood that a value of “7” could also be used if the step of incrementing the value of “X” occurs at a different location in the process 600. If the answer to step 604 is “no,” the microprocessor 310 moves to step 606. Otherwise, the microprocessor 310 moves to step 608.

According to step 606, the microprocessor 310 places a seed value into Buffer (Ø, X), which in the first instance is Buffer (Ø, Ø). The seed value is an empirically derived value that is relatively close to the level value anticipated to be found. In other words, the seed value is experimentally determined based on actual values observed in a particular CATV system. The seed value needs to be relatively close to the initial level value of the upstream bandwidth to allow the conditioning device 100 to start a stabilization process. After filling Buffer (Ø, X) with the seed value, the microprocessor returns to step 604 to check whether Buffer Ø is full. This process between steps 604 and 606 continues to fill all of the Buffer Ø input locations with the seed value. Once full, the microprocessor moves to step 608.

According to step 608, the microprocessor 310 is to obtain a CAV of the Buffer Ø, and place that value in Buffer (1, Y), which in this first instance is Buffer (1, Ø). The microprocessor resets the Buffer Ø input location X to Ø, but leaves the seed values in the Buffer Ø input locations. One skilled in the art would understand that the present process will function normally if the values in Buffer Ø are erased or left as is to be written over at a later time.

Further in accordance with step 608, a high voltage limit (“VIH”) and a low voltage limit (“VIL”) are calculated based on the CAV value placed into Buffer (1, Y), which is currently Buffer (1, Ø). Note that this could also be worded as calculating VIH and VIL based on the CAV. Regardless, VIH and VIL are calculated values that are used in later steps to exclude a vast majority of level values that are not near the expected level values. This exclusion helps to make the present conditioning device 100 more stable by avoiding mistaken peak value measurements that are far below the expected values. Because both VIH and VIL are determined after every new CAV is determined, VIH and VIL are allowed to float in the event of a large change in the level values received. In the present instance, VIH is to be approximately 94% of the Buffer (1, Y), and VIL is to be approximately 81% of the Buffer (1, Y). Both VIH and VIL may be other ratios that allow for more or less level values to be included in any peak value determination. The peak value determination will be discussed further below, but it may be helpful to explain here that VIH sets a high initial threshold where level values below VIH are excluded from consideration. Similarly, VIL is a low secondary threshold where level values are considered until a level value of a particular series (a series starting when a level value exceeds VIH) is below VIL. In other words, a series of level values will be examined for a single peak value, the series beginning with a level value exceeding VIH and ending with a level value falling below VIL. Because the most recent CAV is the seed value of 51, VIH is calculated to be 48 and VIL is calculated to be 41. These values will, of course, change as the CAV changes after actual level values are obtained. After completion of the present step, the microprocessor moves to step 610.

In accordance with step 610, the microprocessor 310 obtains a current level value (“CLV”). The CLV is the value of the voltage provided by the non-linear amplifier 380 (FIG. 3) at the current time. Once a CLV is obtained, the microprocessor proceeds to step 612.

According to step 612, the microprocessor 310 looks to see whether the recently obtained CLV is greater than VIH to start considering a series of level values. As mentioned above, if the particular CLV is the first obtained value (since having a value fall below VIL) that is greater than VIH, it is the first of a series. Accordingly, if the CLV is below VIH, the microprocessor 310 proceeds to step 614 to determine whether CLV is less than VIL, which if true would stop the series. If the CLV is greater than VIH, the next step is step 618.

According to step 614, the microprocessor 310 looks to see whether the recently obtained CLV is less than VIL. As mentioned above, all of the level values obtained that fall below VIL are eliminated from consideration. The process 600 moves to step 616 when the CLV is less than VIL. Accordingly, if the CLV is greater than VIL, the next step is back to step 610 to obtain a new CLV to continue the series started by having a CLV greater than VIH. It should be understood that any of these comparisons to VIH and VIL may be equal to or less/greater than instead of merely less/greater than. The additional values used or not used would not significantly alter the result.

Once the microprocessor 310 proceeds through step 616 a sufficient number of times incrementing the Buffer Ø input location X, step 622 will be satisfied indicating that the Buffer Ø is ready to be averaged. Accordingly, once step 622 is satisfied the microprocessor 310 moves to step 624.

In accordance with step 624, the microprocessor 310 calculates a CAV, which is the average of Buffer Ø, and sets the Buffer Ø input location X to Ø. The microprocessor 310 then proceeds to step 626.

In accordance with step 626, the microprocessor determines whether CAV is greater than the value of Buffer (1, Y)+6. To add clarity to this step, if Buffer (1, Y) is 51, the microprocessor is determining whether the CAV is greater than 51+6, or 57. This value of “6” added to the Buffer (1, Y) value adds stability to the process 600, in that the CAV must be sufficiently high in order to add additional attenuation in step 629. Accordingly, a larger value than “6” may be used to add greater stability at the risk of reducing accuracy. Similarly, a value less than “6” may be used to add greater accuracy at the risk of reducing stability. The microprocessor 310 moves to step 629 to add attenuation if step 626 is answered in the affirmative. Otherwise, the microprocessor 310 moves to step 628.

In accordance with step 629, the microprocessor 310 adds an additional step of attenuation, which in the present embodiment is 1 dB. Additionally, the microprocessor increments the Buffer 1 input location Y in preparation for placing the CAV into Buffer 1. Afterward, the microprocessor moves to step 631.

In accordance with step 631, the microprocessor 310 determines whether the Buffer 1 input locations are full. Because there are only eight input locations in Buffer 1, (Ø-7) a value of 8 would indicate that the Buffer 1 is full. The reason for this will become evident below. If the Buffer 1 is full, the next step is step 634. Otherwise, the next is step 632.

In accordance with step 632, the CAV is placed in the next open Buffer 1 input location, Buffer (1, Y). The process then proceeds to step 636.

If the Buffer 1 is full, the microprocessor 310 would have proceeded to step 634 instead of step 632. In accordance with step 634, all of the values currently in Buffer 1 are shifted down 1 location such that the value originally (i.e., before step 634) in Buffer (1, Ø) is removed from Buffer 1. The CAV is then placed in Buffer (1, 7). Further in step 634, the Buffer 1 input location Y is set to 7. As with step 632, the process 600 proceeds to step 636.

In accordance with 636, the microprocessor 310 calculates a new values for VIH and VIL from Buffer (1, Y), which may be Buffer (1, 7) if step 364 was previously accomplished. After step 636, the process 600 returns to step 610 to obtain a new CLV and the relevant portions of process 600 are reiterated.

Referring now back to step 628, the microprocessor 310 determines whether the CAV is less than the value in Buffer (1, Y)−4. Using a value for Buffer (1, Y) of 51, the microprocessor would be determining whether CAV is less than 51-5, or 47. In this example, the process 600 will move to step 630. Otherwise, the process 600 will move to step 638, which will be discussed later.

In accordance with step 630, the microprocessor 310 determines whether the setback timer has timed out. If the answer is no, the microprocessor 310 proceed to step 646 where the setback timer is reset. Otherwise, the microprocessor 310 moves to step 642.

In accordance with step 642, the microprocessor 310 looks to see whether the Buffer 1 input location Y is greater than or equal to 4. If so, the microprocessor 310 moves to step 644 where the amount of attenuation applied by the variable attenuator 320 is reduced by 4, and the Buffer 1 input location Y is reduced by 4. A value other than “4” may be used if more or less of an attenuation reduction is desired based on time. The value of 4 has been found to be a suitable tradeoff between applying enough reduction in attenuation to ease any additional loads on the premise devices and reacting too quickly to the non-use of premise devices. Afterward, the microprocessor 310 moves to step 646 where the setback timer is reset.

Referring back to step 648, if Y was not greater than or equal to 5 in step 642, the amount of attenuation applied by the variable attenuator 320 will be reduced to the base amount of 4 set in step 602, and the Buffer 1 input location Y will be set to Ø. Afterward, the microprocessor 310 moves to step 646 where the setback timer is reset.

Referring back to step 638, if the microprocessor determined that Buffer 1 input location Y is Ø, the microprocessor moves directly to step 636 to calculate a new VIH an VIL. Otherwise, it is apparent that the variable attenuator 320 may be reduced in step 640 by one step, which in the present embodiment is 1 dB. Also in step 640, the Buffer 1 input location Y is reduced by one. Afterward, the microprocessor moves to step 636.

Step 636 is the final step in the process 600 before the process 600 is restarted, absent the initialization process, at step 610. The microprocessor 310 may continuously proceed through process 600 as processing time allows.

Referring now back to FIG. 3, the amount of attenuation determined by the process 600 is added and reduced using a variable attenuator 320, which is controlled by the microprocessor 310. Based on the present disclosure, it should be understood by one skilled in the art that there are a variety of different hardware configurations that would offer variable attenuation. For example, an embodiment of the conditioning device 100 could include a fixed attenuator and a variable amplifier, which is connected and controlled by the microprocessor 310. Other embodiments are envisioned that include both a variable amplifier and a variable attenuator. Further, the variable signal level adjustment device could also be an automatic gain control circuit (“AGC”) and function well in the current device. In other words, it should also be understood that the amount of signal level adjustment and any incremental amount of additional signal level adjustment can be accomplished through any of a wide variety of amplification and/or attenuation devices.

In light of the forgoing, the term “variable signal level adjustment device” used herein should be understood to include not only a variable attenuation device, but also circuits containing a variable amplifier, AGC circuits, other variable amplifier/attenuation circuits, and related optical circuits that can be used to reduce the signal strength on the upstream bandwidth.

(iii) Downstream Section

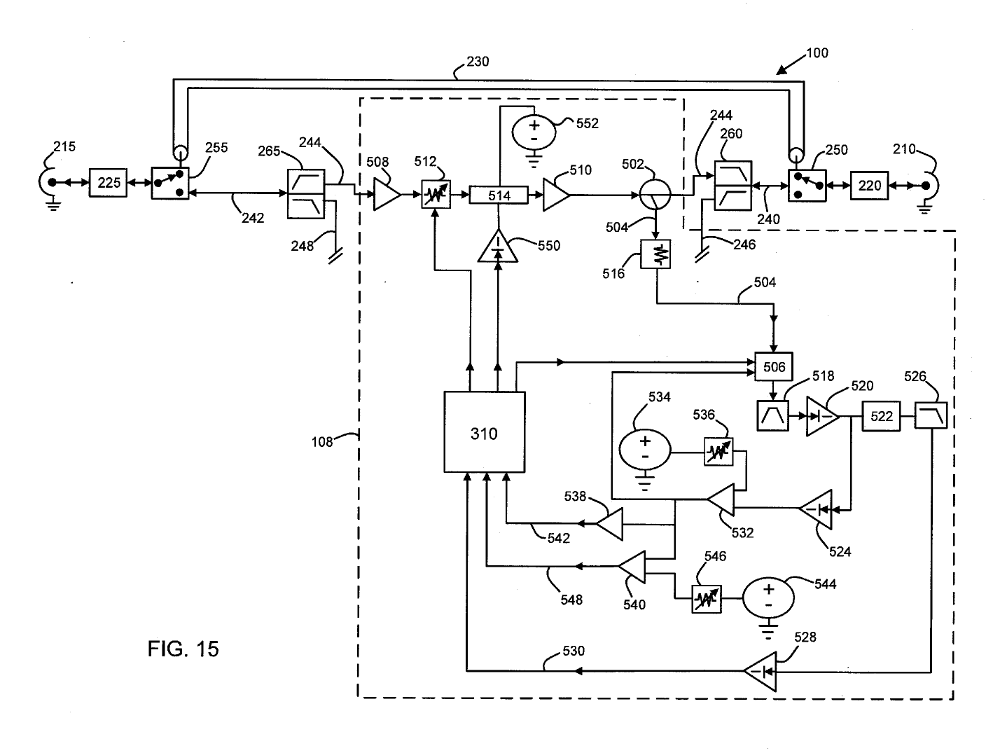

Referring back to FIG. 3 and now to FIG. 15, the conditioning device 100 made in accordance with the present embodiment further includes a downstream section 108 connected within the forward path 244.

Generally, the downstream section 108 uses the microprocessor 310 to seek and observe channel level data using two different modes of operation, Mode Ø and Mode 1. In Mode Ø, the microprocessor 310 uses only a single high frequency channel and single low frequency channel to make relatively course/large corrections in terms of level and slope. In Mode 1, the microprocessor 310 uses an average of more than one high frequency channel and an average of more than one low frequency channels to make relatively fine corrections in terms of level and slope. In each Mode within the present embodiment, the level of the high frequency channel(s) is used to set the amplification, while the level of the low frequency channel(s) is used to set the slope. It should be understood that the level of the high frequency channel(s) may be used to set the amplification and the level of the low frequency channel(s) may be used to set the slope in a similar many to that described below. The hardware, control, and operation of the downstream section 108 will be discussed in further detail below.

In the present embodiment, the microprocessor 310 is the same microprocessor as the one used in the upstream section 310. It may be beneficial, however to use two or more separate microprocessors 310 if there is some advantage, such as cost, space, or complexity, to do so. In the event that two separate microprocessors 310 are used, there may be a connection there between to allow for the passage of information. As will be discussed below, there are advantageous reasons for having the downstream section 108 provide information to the upstream section 105.

Beginning first with the hardware, a coupler 502 is connected within the forward path 244 to pass a portion of the downstream bandwidth (referred to herein as a coupled downstream bandwidth) via a secondary path 504 toward a tuner 506. The coupler 502 is connected within the forward path 244 between the user side diplexer 260 and functional components (e.g., amplifiers 508, 510, a variable attenuator 512, and a slope adjustment device 514, all discussed in further detail below) that are used to condition the downstream bandwidth by correcting the level and slope of the downstream bandwidth. This positioning of the coupler 502 allows the downstream bandwidth to be sampled and analyzed after it has been conditioned. The coupler 502 used in the present embodiment is a traditional directional coupler to endure a continuous characteristic impedance. Other devices, such as a simple resistor, and/or a splitter may be used with careful consideration of the effects that these alternatives may have on the characteristic impedance of the device.

A fixed signal level adjustment device 516 may be positioned between the coupler 502 and the tuner 506. The fixed signal level adjustment device 516 may be used to prevent the coupler 502 from drawing too much power from the downstream bandwidth. Further, the fixed signal level adjustment device 516 may be sized to provide the tuner 506 with the coupled downstream bandwidth having an appropriate amount of power for the tuner 506 and subsequent devices. Accordingly, one skilled in the art would understand, based on the present disclosure, whether the fixed signal level adjustment device 516 is required and what size of the fixed signal level adjustment device 516 is required for any particular coupler 502 and tuner 506 combinations.

The tuner 506 is a traditional tuner device that can be “tuned” to selected channels based on an input from the microprocessor 310. In particular the tuner 506 used in the present embodiment is provided with a target index number (Index #) that corresponds with CATV channels, as shown below in Table 1. The purpose for pointing out these index numbers is to show that CATV channels have not been introduced in an orderly fashion. For example, CATV channel 95 (Index # 5) is lower in frequency than CATV channel 14 (Index #10). Accordingly, the present microprocessor 310 controls the tuner 506 based on an index number that increments in ascending order along with the frequencies that the Index # represents. The purpose of these index numbers, will become more evident below. A more powerful microprocessor 310 and/or a more complex software control may use a alternative method to selecting channels other than the index of channels, shown below.

TABLE 1

Channel Bandwidth

| Index # | Channel Designator | Low end | High End |
|---|---|---|---|
| 0 | 2 | 54 | 60 |
| 1 | 3 | 60 | 66 |
| 2 | 4 | 66 | 72 |
| 3 | 5 | 76 | 82 |
| 4 | 6 | 82 | 88 |
| 5 | A-5 (95) | 90 | 96 |
| 6 | A-4 (96) | 96 | 102 |
| 7 | A-3 (97) | 102 | 108 |
| 8 | A-2 (96) | 108 | 114 |
| 9 | A-1 (99) | 114 | 120 |
| 10 | A (14) | 120 | 126 |
| 11 | B (15) | 126 | 132 |
| 12 | C (16) | 132 | 138 |
| 13 | D (17) | 138 | 144 |
| 14 | E (18) | 144 | 150 |
| 15 | F (19) | 150 | 156 |
| 16 | G (20) | 156 | 162 |
| ~ . . . | ~ . . . | ~ . . . | ~ . . . |
| 94 | C91 | 624 | 630 |
| 95 | C92 | 630 | 636 |
| 96 | C93 | 636 | 642 |
| 97 | C94 | 642 | 648 |
| 98 | C100 | 648 | 654 |
| 99 | C101 | 654 | 660 |
| 100 | C102 | 660 | 666 |
| 101 | C103 | 666 | 672 |
| 102 | C104 | 672 | 678 |
| 103 | C105 | 678 | 684 |
| 104 | C106 | 684 | 690 |
| 105 | C107 | 690 | 696 |
| 106 | C108 | 696 | 702 |
| 107 | C109 | 702 | 708 |
| 108 | C110 | 708 | 714 |
| 109 | C111 | 714 | 720 |
| ~ . . . | ~ . . . | ~ . . . | ~ . . . |

The output voltage stream from the tuner 506 is typical of tuners in that the voltage stream is arranged in the frequency domain, and in that the voltage stream is a 6 MHz spectrum consistent with a includes a standardized analog television channel regardless of the frequencies of the channel that being observed at the time.

A relatively narrow band-pass filter 518 may be electrically connected to an output of the tuner 506. The band-pass filter 518 removes extraneous signals above and below desired frequencies (e.g., a vertical synchronization frequency) provided by the tuner 506. Alternatively, the band-pass filter 518 may be replaced by a low-pass filter, as the vertical synchronization frequency is modulated low within the range of frequencies in accordance with NTSC. Similarly, the band-pass filter 518 may be replaced by a high-pass filter that removes extraneous signals below other desired frequencies provided by the tuner, such as the horizontal synchronization frequency. It should be understood that differing frequencies may need to be selected depending on the analog modulation scheme (e.g., NTSC, PAL, SECAM, etc.) expected. A resulting frequency domain voltage stream is then passed to an RF detector 520.

The RF detector 520 converts the frequency domain voltage stream passed from the band-pass filter 518 into a time domain voltage stream. More specifically, the RF detector 520 performs the effect of an inverse Laplace transform, the Laplace transform being a widely used intregal transform, to make the transition from the frequency domain to the time domain As discussed above, the inverse Laplace transform is given the following complex integral, which is known by various names, the Bromwich integral, the Fourier-Mellin integral, and Mellin's inverse formula. Also as described above, an alternative formula for the inverse Laplace transform is given by Post's inversion formula. Accordingly, any other device capable of such a conversion from the frequency domain to the time domain may be used in place of the RF detector 520. Afterward, the time domain voltage stream is passed to both a synchronization detector 522 (“sync detector 522”) and a low frequency level detector 524.

The sync detector 522 synchronizes with voltage streams having a relatively continuous repetition, such as a continuous 30 Hz tone. Without such a continuous tone, the sync detector 522 provides a random output voltage stream. The voltage stream output, either random or synchronous, is then passed to a low-pass filter 526.

The low-pass filter 526 is provided to attenuate high frequencies which may appear like synchronous frequencies to a peak detector 528. The low-pass filter 526 may be configured such that it allows frequencies up to at least 30 Hz to include desired sync frequencies and to exclude those above the desired frequencies. The low-pass filter 526 may also include an input blocking capacitor to exclude very low frequencies.

The peak detector 528 produces a relatively consistent voltage stream when a voltage stream including synchronous voltages is provided from the sync detector 522 and the low-pass filter 526. In the presence of a voltage stream including random, non-synchronous voltages, the peak detector 528 is unable to produce a voltage stream that is consistently a significant voltage above ground. The peak detector 528 may also be an integrator performing a similar function.

A resulting voltage stream from the peak detector 528 is input along a path 530 into the microprocessor 310 as a signal that discriminates between analog modulation channels and digital modulation channels. More specifically, the voltage stream from the peak detector 528 indicates that the tuner 506 is tuned to an analog modulation channel when the voltage stream is consistently a significant voltage above ground. Conversely, the voltage stream from the peak detector 528 indicates that the tuner 506 is tuned to a digital modulation channel when the voltage stream is consistently near ground.

As mentioned above, the voltage stream from the RF detector 520 is also passed to the level detector 524, which helps to maintain a voltage level from the RF detector for a longer period of time. In other words, voltages within the voltage stream are held (from falling) at their particular rate for a duration longer than in the original voltage stream passed into the level detector 524. The voltage stream from the RF detector 520 is then input into a DC shift amplifier 532. The level detector 524 may also be known as a peak detector.

The DC shift amplifier 532 may be used as a low pass amplifier to provide a voltage stream that has been shifted in scale by a known amount to render the signal voltages appropriate for the microprocessor 310. The amount of voltage shift and/or amplification is determined by a voltage source 534 connected to the DC shift amplifier 532 by an adjustable attenuator 536. Accordingly, the DC shift amplifier 532 may also be known as a low-pass amplifier. A portion of the voltage stream from the DC shift amplifier 532 is passed back to the tuner 506 as a control. Also, a portion of the voltage stream from the DC shift amplifier 532 is passed to a high-gain amplifier 538, and a portion of the voltage stream from the DC shift amplifier 532 is passed to a low-gain amplifier 540.

The amplifier 538 is provided with the voltage stream from the DC shift amplifier 532 to function as a voltage comparator. This arrangement provides a voltage stream in a path 542 to the microprocessor 310 to identify the occurrence of a transmitted channel present at the index number tuned by the tuner 506.

The low-gain amplifier 540 is also provided with the voltage stream passing from the DC shift amplifier 532. The voltage stream created by the low-gain amplifier 540 is shifted in response to the voltage source 544, which is connected to the low-gain amplifier 540 via an adjustable attenuator 546. The resulting voltage stream from the low-gain amplifier 540 is relative to the level of the channel at the tuned index number. This arrangement provides a voltage stream in a path 548 to the microprocessor 310 to identify the level of a transmitted channel present at the index number tuned by the tuner 506.

For a more detailed description of the hardware and operation of the hardware used to generate the respective voltage streams along the path 530, the path 542, and the path 548, please refer to U.S. Ser. No. 12/576,278, an entirely of which is incorporated herein by reference.

The remaining portions, discussed below, of the downstream section 108 helps to perform the actual downstream conditioning functions at the direction of the microprocessor 310. The actual control sequences of these devices will be discussed more fully below, but the functionality of the hardware will be discussed here in detail first.

An amplifier 508 may be provided at or near a first location, in terms of the flow of the downstream bandwidth, in the downstream section 108. The amplifier 508 may perform at least two functions. First, amplifier 508 may add additional level to the downstream bandwidth to account for inherent attenuation in the diplexer 265, the switch 255 and so on. Second, the amplifier 508 may add some or all of the amplification needed to correct the level and slope of the downstream bandwidth as part of an output compensation circuit. For example, in the embodiment shown, the amplifier 508 is a fixed output design (i.e., not controlled by the microprocessor 310), while an adjacent variable attenuator 512 is controlled by the microprocessor 310. As would be understood by one skilled in the art, a gain of 10 db may be realized by including a fixed 24 db amplifier and 14 db of attenuation. Along these lines, it should be understood that the combination of the amplifier 508 and the variable attenuator 512 is only one method of configuring an output compensation circuit that may be used to vary an amplification/level. There are many other configurations that could result in variable amplification. For example, the same desired amplification may be possible using a variable amplifier with no subsequent attenuation device. Further, any of the known adjustable gain control (“AGC”) circuits may replace the amplifier 508 and the variable attenuator 512.

A slope adjustment circuit 514 is also provided. The slope adjustment circuit 514 varies the slope of the downstream bandwidth in response to a voltage provided from a rectifier 550. The slope adjustment circuit 514 provides a non-linear amount of attenuation that resembles the curve of inherent attenuation caused by the passage of the downstream bandwidth through traditional signal cables. More specifically, the slope adjustment circuit 514 provides a non-linear attenuation where the higher frequencies are attenuated less than lower frequencies, the non-linear curve being similar to the attenuation curve resulting from the signal cable. Accordingly, a downstream bandwidth having a characteristic slope after passing a length through signal cable (the slope being a non-liner curve with greater attenuation of the higher frequencies) may be made flat, or be made with a slight upward slope with the slope adjustment circuit 514.

Importantly, the slope adjustment circuit 514 does not provide amplification to the downstream bandwidth in order to flatten the levels across the downstream bandwidth. Instead, the slope adjustment circuit 514 attenuates the frequencies having higher levels. Accordingly, the presence of at least one amplifier 508, 510 and some form of control for the amplifiers 508, 510 (e.g., the variable attenuator 512) will be required to condition the downstream bandwidth in terms of slope and level.

The slope adjustment circuit 514 used in the embodiment represented in FIG. 3 varies the slope based on voltage. Because the microprocessor 310 used in the embodiment does not precisely output varying voltages, pulse width modulation (PWM) is used to control the slope adjustment 514. The PWM signal output by the microprocessor 310 is converted in to a correspondingly varying voltage by the rectifier 550, which may also be an integrator. A reference voltage is provided to the slope adjustment circuit 514 by a voltage source 552. The PWM signal may be replaced with a digital control with a analog output, as would be understood by one skilled in the art provided with the present description.

Now, the remainder of the description relates to the microprocessor 310, and how it uses the information provided to correct the level and slope of the downstream bandwidth.

A first, relatively important step is to calibrate the downstream section 108. While the calibration itself may not be important, the description of the calibration helps to introduce a number of terms useful for the remainder of the description. The calibration is accomplished by attaching the conditioning device 100 to a matrix generator, which provides the downstream device with at least two known levels, such as 0 dBmV and 20 dBmV, at every index number. The calibration sequence proceeds with the tuner 506 incrementing through each Index # (from the chart provided above) and obtaining a calibration level for each index number. In the present embodiment, this calibration level is saved as a digital value between 0 and 255. The following is a chart of sample calibration levels, the values being chosen for exemplary purposes only:

TABLE 2

| | | Calibration Level | |
|---|---|---|---|
| Index # | Channel Designator | Low end 0 dBmV | High End 20 dBmV |
| 0 | 2 | 155 | 210 |
| 1 | 3 | 165 | 225 |
| 2 | 4 | 155 | 218 |
| 3 | 5 | 160 | 223 |
| 4 | 6 | 155 | 214 |
| 5 | A-5 (95) | 148 | 205 |
| 6 | A-4 (96) | 168 | 224 |
| 7 | A-3 (97) | 168 | 231 |
| 8 | A-2 (96) | 159 | 217 |
| 9 | A-1 (99) | 163 | 224 |
| 10 | A (14) | 168 | 226 |
| 11 | B (15) | 150 | 213 |
| 12 | C (16) | 163 | 226 |
| 13 | D (17) | 167 | 224 |
| 14 | E (18) | 167 | 228 |
| 15 | F (19) | 161 | 224 |
| 16 | G (20) | 149 | 220 |
| ~ . . . | ~ . . . | ~ . . . | ~ . . . |
| 94 | C91 | 163 | 231 |
| 95 | C92 | 166 | 220 |
| 96 | C93 | 162 | 219 |
| 97 | C94 | 148 | 208 |
| 98 | C100 | 175 | 218 |
| 99 | C101 | 162 | 212 |
| 100 | C102 | 163 | 211 |
| 101 | C103 | 172 | 235 |
| 102 | C104 | 172 | 231 |
| 103 | C105 | 158 | 202 |
| 104 | C106 | 162 | 218 |
| 105 | C107 | 151 | 209 |
| 106 | C108 | 161 | 217 |
| 107 | C109 | 163 | 213 |
| 108 | C110 | 168 | 215 |
| 109 | C111 | 159 | 216 |
| ~ . . . | ~ . . . | ~ . . . | ~ . . . |

Even though two calibration values are shown below for each channel, it is possible to use only one calibration value for each, with at least one assumption. For example, one calibration value only may be used if/when an assumed increment is used for voltage changes. Alternatively, more than two calibration values may be used to ensure even more accurate measurements and correction, but at the expense of greater complexity.

Based on the obtained calibration values, goals for level and slope may be obtained through interpolation of the calibration values. For example, if a CATV provider determines that the levels should be 12 dBmV (or 14 dBmV) for the channels with no upward slope, the goals for each of the channels may be as follows:

TABLE 3

Interpolated Goals

| Index # | Channel Designator | 12 dBmV | 14 dBmV |
|---|---|---|---|
| 0 | 2 | 188 | 194 |
| 1 | 3 | 201 | 207 |
| 2 | 4 | 193 | 199 |
| 3 | 5 | 198 | 204 |
| 4 | 6 | 190 | 196 |
| 5 | A-5 (95) | 182 | 188 |
| 6 | A-4 (96) | 202 | 207 |
| 7 | A-3 (97) | 206 | 212 |
| 8 | A-2 (96) | 194 | 200 |
| 9 | A-1 (99) | 200 | 206 |
| 10 | A (14) | 203 | 209 |
| 11 | B (15) | 188 | 194 |
| 12 | C (16) | 201 | 207 |
| 13 | D (17) | 201 | 207 |
| 14 | E (18) | 204 | 210 |
| 15 | F (19) | 199 | 205 |
| 16 | G (20) | 192 | 199 |
| ~ . . . | ~ . . . | ~ . . . | ~ . . . |
| 94 | C91 | 204 | 211 |
| 95 | C92 | 198 | 204 |
| 96 | C93 | 196 | 202 |
| 97 | C94 | 184 | 190 |
| 98 | C100 | 201 | 205 |
| 99 | C101 | 192 | 197 |
| 100 | C102 | 192 | 197 |
| 101 | C103 | 210 | 216 |
| 102 | C104 | 207 | 213 |
| 103 | C105 | 184 | 189 |
| 104 | C106 | 196 | 201 |
| 105 | C107 | 186 | 192 |
| 106 | C108 | 195 | 200 |
| 107 | C109 | 193 | 198 |
| 108 | C110 | 196 | 201 |
| 109 | C111 | 193 | 199 |
| ~ . . . | ~ . . . | ~ . . . | ~ . . . |

Similarly, if a CATV provider determines that they would like a 12 dBmV to 14 dBmV upward slope between 54 MHz and 1000 MHz to the downstream bandwidth, the following values could be interpolated as goals:

TABLE 4

| | | Interpolated Goals for 12 dBmV-14 dBmV | |
|---|---|---|---|
| | | Upslope Between 54 MHz and 1000 MHz | |
| Index # | Channel Designator | dBmV | Value |
| 0 | 2 | 12.0000 | 188 |
| 1 | 3 | 12.0127 | 201 |
| 2 | 4 | 12.0255 | 193 |
| 3 | 5 | 12.0382 | 198 |
| 4 | 6 | 12.0510 | 191 |
| 5 | A-5 (95) | 12.0637 | 182 |
| 6 | A-4 (96) | 12.0764 | 202 |
| 7 | A-3 (97) | 12.0892 | 206 |
| 8 | A-2 (96) | 12.1019 | 194 |
| 9 | A-1 (99) | 12.1146 | 200 |
| 10 | A (14) | 12.1274 | 203 |
| 11 | B (15) | 12.1401 | 188 |
| 12 | C (16) | 12.1529 | 201 |
| 13 | D (17) | 12.1656 | 202 |
| 14 | E (18) | 12.1783 | 204 |
| 15 | F (19) | 12.1911 | 199 |
| 16 | G (20) | 12.2038 | 192 |
| ~ . . . | ~ . . . | ~ . . . | ~ . . . |
| 94 | C91 | 13.2102 | 208 |
| 95 | C92 | 13.2229 | 202 |
| 96 | C93 | 13.2357 | 200 |
| 97 | C94 | 13.2484 | 188 |
| 98 | C100 | 13.2611 | 204 |
| 99 | C101 | 13.2739 | 195 |
| 100 | C102 | 13.2866 | 195 |
| 101 | C103 | 13.2994 | 214 |
| 102 | C104 | 13.3121 | 211 |
| 103 | C105 | 13.3248 | 187 |
| 104 | C106 | 13.3376 | 199 |
| 105 | C107 | 13.3503 | 190 |
| 106 | C108 | 13.3631 | 198 |
| 107 | C109 | 13.3758 | 196 |
| 108 | C110 | 13.3885 | 199 |
| 109 | C111 | 13.4013 | 197 |
| ~ . . . | ~ . . . | ~ . . . | ~ . . . |

It should be understood that these interpolated goals may be calculated at any time by the microprocessor 310 or may be provided to the microprocessor in table form. It is being described at this point to aid in clarifying the use of goal values and how those goal values are obtained. Depending of the software strategy and microprocessor 310, the use of goals in terms of their interpolated digital scaled value may be unnecessary. For example, the digitally scaled level value of a particular channel may be converted to a representative dBmV scale such that the goals may remain in the dBmV scale. Further, it should be understood that many of the remaining components, like the slope adjustment device 514 may be calibrated to determine an amount of response of that device in terms of an amount of input from the microprocessor 310.

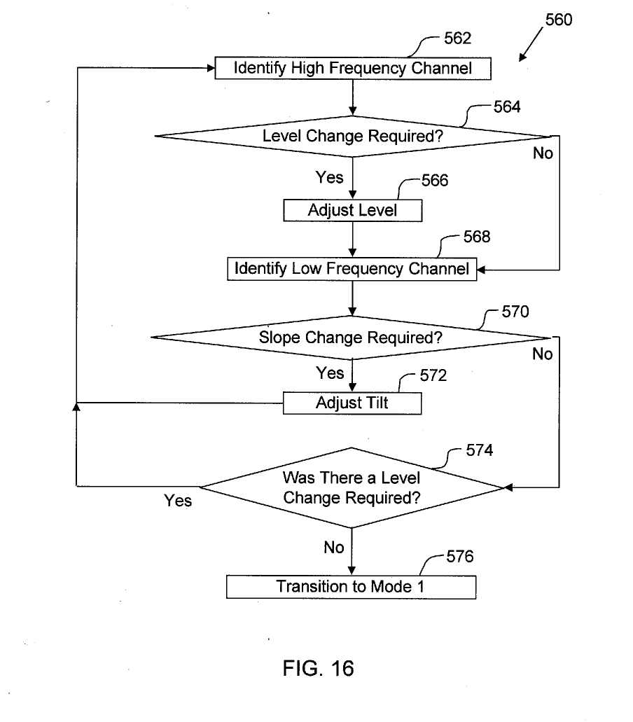

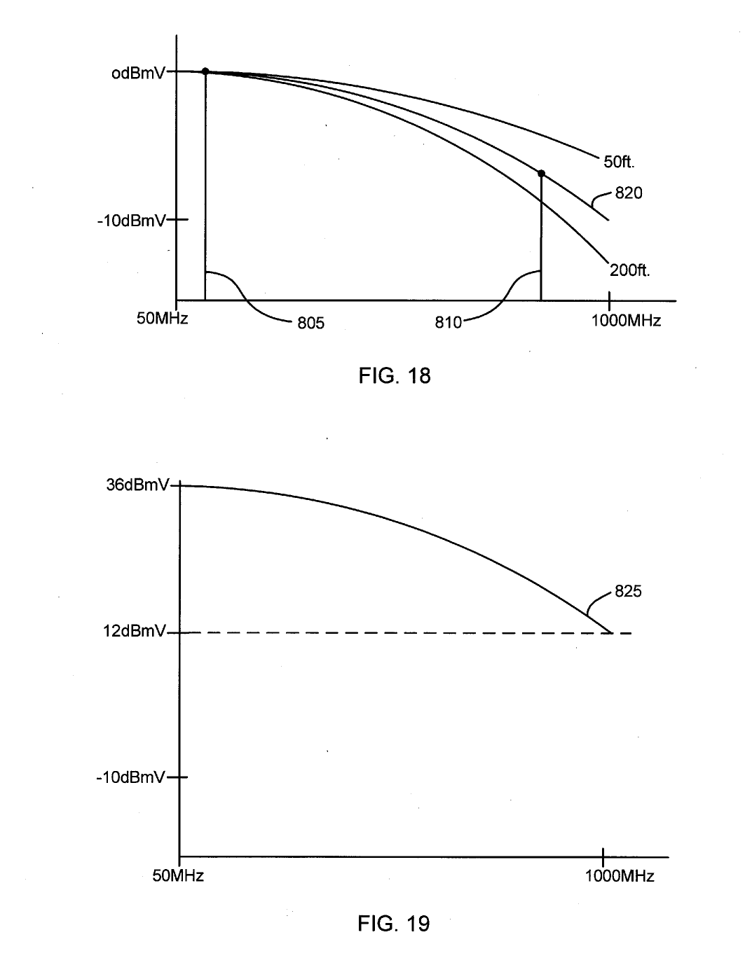

After calibration and in use on or proximate to a premise of a user, the microprocessor 310 initiates Mode Ø, which is an initial process correcting the level of the channels and the slope in a relatively quick manner. Mode Ø will be discussed using the flow chart shown in FIG. 16 along with relative examples in FIGS. 18-21.

According to step 562, the microprocessor 310 attempts to identify a high frequency channel 810 (FIG. 18). The microprocessor 310 first attempts to identify the high frequency channel 810 at Index #103. If no channel is found at Index #103, the microprocessor 810 then begins to scan at Index #105 and indexes down until a high frequency channel 810 is identified as being present. The particular index number used may be different in other embodiments However, it is important to identify a channel as being present because a channel should be present to obtain accurate level values. In a representative CATV system, it was found that there are typically channels present in the range of Index #101 to 105. Accordingly, these index numbers should be changed to a location where channels are typically present in a particular CATV system, if needed.

The microprocessor 310 then obtains a level measurement for the identified channel. If the microprocessor 310 determines that the identified channel is digital, through the method described above, the microprocessor 310 will add 10 dBmV onto the measured Level for that channel. The associated digital value for an offset of 10 dBmV is shown in the Table below.

TABLE 5

| | | Interpolated Values per dBmV Goals | |
|---|---|---|---|
| Index # | Channel Designator | 1 dBmV | 10 dBmV |
| 0 | 2 | 2.75 | 27.5 |
| 1 | 3 | 3.00 | 30.0 |
| 2 | 4 | 3.15 | 31.5 |
| 3 | 5 | 3.15 | 31.5 |
| 4 | 6 | 2.95 | 29.5 |
| 5 | A-5 (95) | 2.85 | 28.5 |
| 6 | A-4 (96) | 2.80 | 28.0 |
| 7 | A-3 (97) | 3.15 | 31.5 |
| 8 | A-2 (96) | 2.90 | 29.0 |
| 9 | A-1 (99) | 3.05 | 30.5 |
| 10 | A (14) | 2.90 | 29.0 |
| 11 | B (15) | 3.15 | 31.5 |
| 12 | C (16) | 3.15 | 31.5 |
| 13 | D (17) | 2.85 | 28.5 |
| 14 | E (18) | 3.05 | 30.5 |
| 15 | F (19) | 3.15 | 31.5 |
| 16 | G (20) | 3.55 | 35.5 |
| ~ . . . | ~ . . . | ~ . . . | ~ . . . |
| 94 | C91 | 3.40 | 34.0 |
| 95 | C92 | 2.70 | 27.0 |
| 96 | C93 | 2.85 | 28.5 |
| 97 | C94 | 3.00 | 30.0 |
| 98 | C100 | 2.15 | 21.5 |
| 99 | C101 | 2.50 | 25.0 |
| 100 | C102 | 2.40 | 24.0 |
| 101 | C103 | 3.15 | 31.5 |
| 102 | C104 | 2.95 | 29.5 |
| 103 | C105 | 2.20 | 22.0 |
| 104 | C106 | 2.80 | 28.0 |
| 105 | C107 | 2.90 | 29.0 |
| 106 | C108 | 2.80 | 28.0 |
| 107 | C109 | 2.50 | 25.0 |
| 108 | C110 | 2.35 | 23.5 |
| 109 | C111 | 2.85 | 28.5 |
| ~ . . . | ~ . . . | ~ . . . | ~ . . . |

Once any offset is applied, the microprocessor 310 determines whether any adjustment is required. In Mode Ø, threshold values are set to determine whether to adjust the level and how much level to adjust. In the present embodiment those thresholds and adjustment amounts are as follows:

TABLE 6

| | | Level Adjustment |
|---|---|---|
| State | Thresholds | Amounts |
| Ø | 0 ≦ Distance from goal in dBmV < 3 dBmV | No Change |
| 1 | 3 ≦ Distance from goal in dBmV < 12 dBmV | 2 dBmV |
| 2 | 12 ≦ Distance from goal in dBmV < 40 dBmV | 8 dBmV |
| 3 | 40 ≦ Distance from goal in dBmV | 24 dBmV |

According to step 564, if the distance from the goal in dBmV falls into any one of States 1-3, the microprocessor 310 moves to step 566 and adjusts the level according to the Table 6 above. If the distance from the goal in dBmV falls into State Ø, the microprocessor moves to step 568. As an example of the level adjustment, a level curve 820 in FIG. 18 is linearly amplified such that a similar level curve 825 (FIG. 19) results. The deference between level curve 820 and 825 is primarily the level, with the level at 1000 MHz being positioned in FIG. 19 at a goal level of 12 dBmV. While it is shown in FIGS. 18 and 19 that the level has been increased over 20 dBmV, this large amount of level adjustment would not be accomplished in one step according to Table 6. This large of an increase in level has been shown in FIGS. 18 and 19 for clarity purposes only.

According to step 568, the microprocessor 310 seeks to identify a low frequency channel 805 (FIG. 18). To do this, the microprocessor 310 first directs the tuner 506 to Index #14. If there is no channel identified at Index #14, the microprocessor 310 then scans through Index #s 12-16 until a channel has been identified. Similar to above, the actual index number of a channel is not important. Rather it is important to identify at least one channel in the lower frequency portion of the downstream bandwidth. After a channel is identified, the microprocessor 310 will obtain a level of that channel and will add 10 dBmV to the level if it is a digital channel.

According to step 570, the microprocessor 310 determines whether any slope changes are required. Similar to above, In Mode Ø, threshold values are set to determine whether to adjust the slope and how much slope to adjust. In the present embodiment those thresholds and adjustment amounts are as follows:

TABLE 7

| | | Slope Adjustment |
|---|---|---|
| State | Thresholds | Amounts |
| Ø | 0 ≦ Distance from goal in dBmV < 3 dBmV | No Change |
| 1 | 3 ≦ Distance from goal in dBmV < 12 dBmV | 2 dBmV |
| 2 | 12 ≦ Distance from goal in dBmV < 40 dBmV | 8 dBmV |
| 3 | 40 ≦ Distance from goal in dBmV | 24 dBmV |

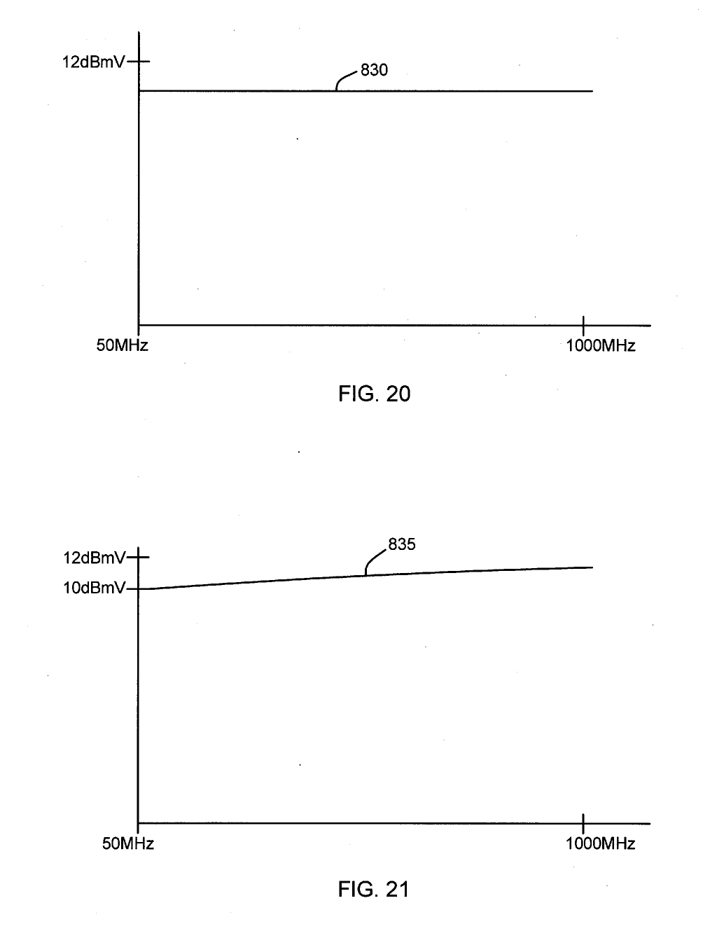

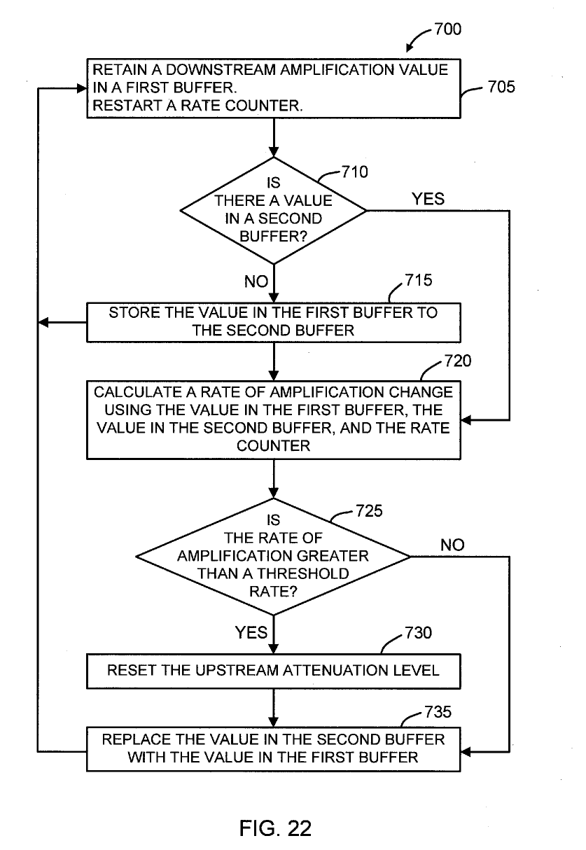

According to step 570, if the distance from the goal in dBmV falls into any one of States 1-3, the microprocessor 310 moves to step 5 and adjusts the slope according to the Table 7 above. If the distance from the goal in dBmV falls into State Ø, the microprocessor 310 moves to step 520. As shown in FIGS. 19 and 20, the level curve 825 is attenuated in a non-linear manner to form a level curve 830 that is shown as being level at 12 dBmV across the frequency range of 54 MHz to 1000 MHz. Similarly, the level curve 825 could be attenuated in a non-linear manner to form a level curve 835 that is shown in FIG. 21 as having an upward slope of 2 MHz between 54 MHz and 1000 MHz. While the level curves 830, 835 are shown as straight lines for clarity purposes, these curves may have many variances between 54 MHz and 1000 MHz.

According to step 570, the microprocessor 310 determines whether any adjustments made to either the level or the slope in the present run through process 560. If there were changes, the microprocessor 310 will return to step 562 and reiterate the process 560. If there were no adjustments made, the microprocessor 310 will proceed to Mode 1.

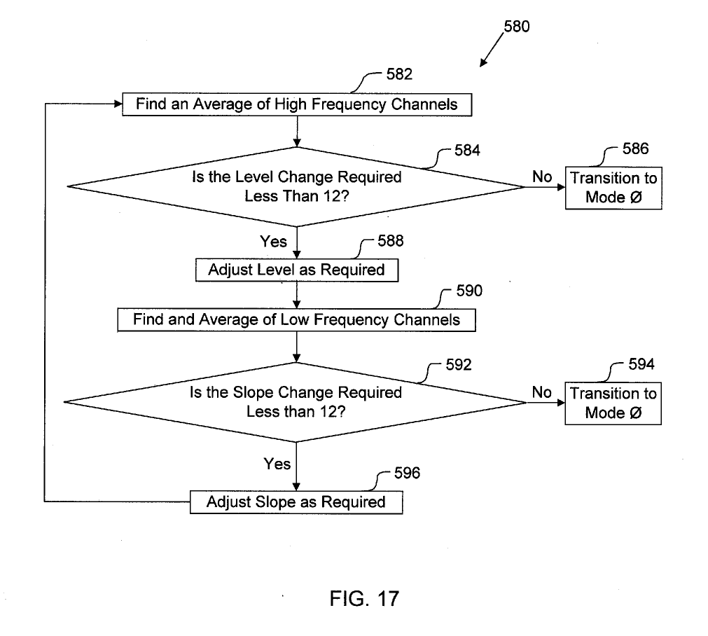

Referring now to FIG. 17, Mode 1 is similar to Mode Ø in that high frequency channels 810 and low frequency channels 805 are sought for the purpose of setting the level and the slope of the downstream bandwidth. The primary difference is that Mode 1 seeks to “fine tune” the level and slope adjustments by using an average of more than one channel. This approach may not be used in Mode Ø, because of the time required to gather the information needed from a larger quantity of channels. It should be understood that the “time required” is a direct result of the amount of time required for the tuner 506 to change channel and any times required to obtain measurements. If timing and quick reactions are not a concern, Mode 1 could be used in place of Mode Ø.

According to step 582, the microprocessor 310 finds an average of more than one high frequency channels. In one embodiment of the downstream section 108, the microprocessor 310 will start at an index number that is five below the starting channel from Mode Ø and stop at an index number that is five above the starting channel from Mode Ø. In other words, the microprocessor 310 will begin collecting channel information at Index #97 (i.e., 103−5) and stop collecting channel information at Index #109 (i.e., 103+5). The microprocessor 310 may also chose the channels based on the index number representing the channel actually identified in Mode Ø, if Index #103 did not contain an identifiable channel Further, it should be understood that less channels may be collected if there is a benefit or a requirement that the process is to be accomplished more quickly. Alternatively, more channels may be collected when or if the process may be allowed to take more time (i.e. more time than with less channels). In other words, less channels may be collected if adjacent channels in a particular CATV system are consistent (i.e. not varying in a random manner), because the benefit of averaging more channels (e.g., smoothing the effects of randomly varying levels in adjacent channels) may be outweighed by the time required to select and measure channels. Similarly, more channels may be collected if adjacent channels in a particular CATV system are greatly varying in a random manner, because the additional time required to select and measure the channels may be outweighed by the additional accuracy obtained by averaging more channels.

Based on the averages of the levels and the goals for the identified channels within the index numbers scanned, the microprocessor 310 will move to step 584 to determine whether any level adjustments are required. If there are index numbers in the range that do not contain identifiable channels, those channels will not be included in terms of average level or average goal. Further, if the microprocessor 310 determines that there are not enough channels in order to obtain a reasonable average, such as a 5 channel average in one embodiment, then the downstream section 108 may not advance into Mode 1 at all, but remain in Mode Ø.

According to step 584, the microprocessor 310 determines whether any level adjustment is required. In Mode 1, threshold values are set to determine whether to adjust the level and how much level to adjust. In the present embodiment those thresholds and adjustment amounts are as follows:

TABLE 8

| | | Level Adjustment |
|---|---|---|
| State | Thresholds | Amounts |
| Ø | 0 ≦ Distance from goal in dBmV < 3 dBmV | No Change |
| 1 | 3 ≦ Distance from goal in dBmV < 12 dBmV | 1 dBmV |
| 2 | 12 ≦ Distance from goal in dBmV | Return to Mode Ø |

Further according to step 584, if the distance from the goal in terms of dBmV falls into any one of States 1, the microprocessor 310 moves to step 588 and adjusts the level according to the Table 8 above. If the distance from the goal in terms of dBmV falls into State 2, the microprocessor moves to step 586, which is to return to Mode Ø. The return to Mode Ø is required in this instance, because the amount of adjustment required may take too long to account for the rapid change that occurred somewhere between the supplier 20 and the downstream section 108. Accordingly, such a return to Mode Ø is a purposeful reaction to what appears to be a rapid change in level, such as when a cable is damaged or an amplifier has rapidly failed.

The microprocessor 310 may then move to step 590, where it finds an average of more than one low frequency channels. In one embodiment of the downstream section 108, the microprocessor 310 will start at an index number that is two below the starting channel from Mode Ø and stop at an index number that is two above the starting channel from Mode Ø. In other words, the microprocessor 310 will begin collecting channel information at Index #12 (i.e., 14−2) and stop collecting channel information at Index #16 (i.e., 14+2). The microprocessor 310 may also choose the channels based on the index number representing the channel actually identified in Mode Ø, if Index #14 did not contain an identifiable channel. The downstream section 108 attempts to collect only five low frequency channels as opposed to eleven high frequency channels in light of the fact that low frequency channels appear to be more consistently present and more consistent in term of level. It should be understood that more or less channels may be collected if speed is a problem and/or if the channels in a particular CATV system are more or less consistent.

Based on the averages of the levels and the goals for the identified channels within the index numbers scanned, the microprocessor 310 will move to step 592 to determine whether any slope adjustments are required. If there are index numbers in the range that do not contain identifiable channels, those channels will not be included in terms of average level or average goal.

According to step 592 the microprocessor 310 determines whether any slope adjustment is required. In Mode 1, threshold values are set to determine whether to adjust the slope and how much level to adjust. In the present embodiment those thresholds and adjustment amounts are as follows:

TABLE 8

| | | Slope Adjustment |
|---|---|---|
| State | Thresholds | Amounts |
| Ø | 0 ≦ Distance from goal in dBmV < 3 dBmV | No Change |
| 1 | 3 ≦ Distance from goal in dBmV < 12 dBmV | 1 dBmV |
| 2 | 12 ≦ Distance from goal in dBmV | Return to Mode Ø |

According to step 592, if the distance from the goal in terms of dBmV falls into any one of States 0 and 1, the microprocessor 310 moves to step 596 and adjusts the slope according to Table 8 above. If the distance from the goal in terms of dBmV falls into State 2, the microprocessor moves to step 594, which is to return to Mode Ø. The return to Mode Ø is required in this instance, because the amount of adjustment required may take too long to account for the rapid change that occurred somewhere between the supplier 20 and the downstream section 108. Accordingly, such a return to Mode Ø is a purposeful reaction to what appears to be a rapid change in level, such as when a cable is damaged or an amplifier has rapidly failed.

It should be understood that minor changes may be made to the above device without significant changes to the design and or operation of the downstream section 108. Most notably, the use of the high frequency channel and the low frequency channel may be switched. More specifically, the downstream section will function normally if the low frequency channel is used to set the level and the high frequency channel is used to set the slope.

### (iv) Interactions Between the Upstream Section 105 and the Downstream Section 108

As mention above, the downstream section 108 transitions from Mode 1 to Mode Ø when there appears to be a rapid change in level, such as when a cable is damaged or and amplifier outside of the conditioning device 100 has failed. The reason for making such a change from Mode 1 to Mode Ø, the downstream section 108 is able to respond to such damage by rapidly increasing the amount of amplification used to achieve a desired level value and/or by rapidly increasing the amount of slope compensation used to achieve a desired slope.

The terminology “rapidly” used herein is relative. It is known that the actual level and slope of a particular CATV system will vary throughout any day because of environmental variances such as temperature changes, sunlight, and moisture. Any changes outside these normal variances typically indicate that damage has occurred or is occurring between the conditioning device 100 and the supplier 20. The normal variances are typically specific to a given CATV system and/or geographic location, and the amount of these normal variances are typically known by technicians servicing that particular CATV system. Accordingly, the terminology “rapidly increasing” indicates that there is a rate of amplification and or a rate of slope that exceeds the rate associated with the normal variances for the particular CATV system.

The terminology “Rate of Amplification” refers to the rate per unit time with which amplification applied to the downstream bandwidth. Similarly, the terminology “Rate of Slope” referred to the rate per unit time with which a slope correction is applied to the downstream bandwidth.

While the downstream section 108 may be able to compensate for damage that has occurred or is occurring in the CATV system between the conditioning device 100 and the supplier 20, the upstream section 105 would not be able to know that any damage has occurred by measuring the desirable upstream bandwidth being generated by the premise device. In fact, the upstream section 105 may create problems when such damage has occurred, because the upstream section 105 effectively removes any additional capacity of the premise device for increasing it output level. In other words, any loss due to damage will add to overall attenuation created by the upstream section 105 such that the premise device will no longer be able to communicate with the supplier 20.

In an effort to have the upstream section 105 account for any damage that has occurred or is occurring in the CATV system between the conditioning device 100 and the supplier 20, the downstream section 108 may provide the microprocessor 310 with an indication that the amplification value and/or the slope correction value are changing rapidly, such as when a transition occurs from Mode 1 to Mode Ø. It should be understood that if the same microprocessor 310 is being used for the operation and control of both sections 105, 108, the microprocessor 310 would not have to receive another indication from the downstream section 108 in order for the microprocessor 310 to adjust the upstream section 105.

Referring now to FIG. 16, a process 700 is described for the operation and control of the upstream section 105 in response to abnormal variances observed from the downstream section 108. As a note, the process 700 is presented and discuss only in terms of amplification (i.e. Amplification Value and Rate of Amplification) for the sake of clarity, it should be understood that the same process 700 is relevant if it were based on slope (i.e. Slope Value and Rate of Slope) or both amplification and slope.

According to step 705, the microprocessor 310 retains a Downstream Amplification Value in a First Buffer. The term “retain” is intended to be broad enough to allow for the possibility where the downstream section 108 includes its own microprocessor, which may send the Downstream Amplification Value to the microprocessor 310, and the term is intended to be broad enough to allow for the possibility where the downstream section 108 uses the microprocessor 310 along with the upstream section 105.

Further according to step 705, the microprocessor 310 restarts a Rate Counter. The Rate Counter is used here to provide some sort of timing function to measure the elapsed time between retained Downstream Amplification Values. Accordingly, there are a variety of other known methods for a microprocessor to measure elapsed time. For example, the microprocessor 310 could include a clock, and the step 705 could include the retention of the time that the Downstream Amplification Value was retained. Similarly, the retention of the Downstream Amplification Value could occur at specific times such that the Rate Counter or other clock would not be needed.

According to step 710, the microprocessor 310 looks to see whether a Value is present in a Second Buffer. This step is present to allow for a start-up condition when there will be no value yet saved in the Second Buffer. If there is no Value in the Second Buffer, as would be the case in an initial run through the process 700, the microprocessor 310 will then store the Value in the First Buffer to the Second Buffer and then return to step 705. If there is a value already in the Second Buffer, the microprocessor 310 will advance to step 720.

According to step 720, the microprocessor 310 will calculate a Rate of Amplification change using the Value in the First Buffer, the Value in the Second Buffer, and the Rate Counter. Specifically, the Value in the Second Buffer is subtracted from the Value in the First Buffer, and the outcome is divided by the Rate Counter. The calculated Rate of Amplification is then passed to step 725.

According to step 725, the microprocessor 310 determines whether the Rate of Amplification is greater than a Threshold Rate. The goal of this step is to determine whether the current observed Rate of Amplification is outside the limits of typical variability for a particular CATV system. The Threshold Rate could also be set quite high, such as at a rate of 3 db per minute, or more. The reason is that damage often occurs quickly, such as when a tree limb falls onto wires or when an automobile hits a pole. Additionally, it is these relatively rapid changes that may adversely affect the ability for the upstream section 105 to account for the damage. If the Rate of Amplification is greater than the Threshold Rate, the Upstream Attenuation Level in the upstream section 105 is reset to remove the added attenuation, in step 730. Otherwise, if the Rate of Amplification is less than the Threshold Rate, no change is made tot the Upstream Attenuation Level. After either outcome, the microprocessor 310 moves to step 735.

According to step 735, the microprocessor 310 replaces the Value in the Second Buffer with the Value in the First Buffer and returns to step 705.

In an alternate embodiment, the downstream section 108 maybe able to provide ongoing Rate of Amplification and/or Rate of Slope information directly from the downstream section. In such an embodiment, the microprocessor 310 would need only to monitor the Rate of Amplification and/or the Rate of Slope and reset the Upstream Attenuation Level when at least one of the Rates exceeds a Threshold Rate.

As mentioned above, in the current embodiment, the downstream section 108 may include a two mode (i.e., Mode Ø and Mode 1) adjustment process for providing amplification and/or slope adjustment. In the first mode, adjustments are made in larger increments, and in the second mode, adjustments are made in smaller increments. In such a scenario, the first mode may be used any time the downstream section 108 determines that large amounts of adjustments (greater and or faster than available in the second stage) are needed. Because any switch from the second mode to the first mode indicates that larger adjustments the amplification and/or slope adjustment are needed, this same switch may be used as an indicator to for the upstream section 105 to reset the Upstream Attenuation Level and remove any added attenuation.

While the present invention has been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements.

1. A device for conditioning a total bandwidth, the device comprising:
a return path extending at least a portion of a distance between a supplier side connector and a user side connector;
a forward path extending at least a portion of a distance between the supplier side connector and the user side connector;
an upstream section comprising a variable signal level adjustment device connected within the return path;
a downstream section comprising a forward coupler connected within the forward path;
at least one microprocessor, the microprocessor being connected electrically upstream the variable signal level adjustment device,
wherein the microprocessor reduces an amount of signal level adjustment applied to the return path in response to a reduction in a level of a downstream bandwidth at the forward coupler.

2. The device of claim 1, wherein the upstream section further comprises:
a return coupler connected within the return path, the coupler providing a secondary path;
a detection circuit connected electrically downstream the return coupler; and
a level detector connected electrically downstream the detection circuit,
wherein the microprocessor is connected electrically downstream the level detector.

3. The device of claim 2, wherein the downstream device further comprises:
a tuner connected to the forward coupler and being tunable based on an input from the microprocessor, the tuner providing a tuner output of a selected channel, the selected channel being at least one of a high frequency channel and a low frequency channel.

4. The device of claim 3, wherein the microprocessor comprises at least one control mode that compares one of the low channel level and the high channel level to a respective goal level.

5. The device of claim 4, wherein the microprocessor comprises a level threshold, a difference between the one of the low channel level and the high channel level and the respective goal level being compared to the level threshold.

6. The device of claim 1, wherein the upstream section and the downstream section utilize their own respective microprocessor, these microprocessors having a communication link there between.

7. The device of claim 1, wherein the upstream section and the downstream section utilize the same microprocessor.

8. A method of conditioning an upstream bandwidth, the method comprising:
adding at least one increment of attenuation to the upstream bandwidth;
measuring a first level of the downstream bandwidth; and
removing at least a portion of the at least one increment of attenuation in response to the first level of the downstream bandwidth.

9. The method of claim 8 further comprising:
measuring a second level of the downstream bandwidth, the second level of the downstream bandwidth being measured an amount of time prior to the measuring of the first level;
comparing the second level of the downstream bandwidth to respective goal level to obtain a second difference;
comparing the first level of the downstream bandwidth to respective goal level to obtain a first difference; and
directing the removal of the portion of the at least one increment of attenuation when the first difference and the second difference vary by a variance greater than a predetermined threshold.

10. The method of claim 9, wherein the predetermined threshold is at least an amount of expected variation, the expected variations including those relating to at least one of cyclical temperatures, humidity, and sunlight.

11. The method of claim 10, wherein the predetermined threshold varies depending on an amount of time between measuring the second level and measuring the first level.

12. The method of claim 8 further comprising:
initiating a first mode, the first mode comprising:
tuning to an initial high frequency channel from a downstream bandwidth;
obtaining a high channel modulation and a high channel level from the initial high frequency channel;
tuning to an initial low frequency channel from the downstream bandwidth;
obtaining a low channel modulation and a low channel level from the initial low frequency channel;
providing an amount of level adjustment of the downstream bandwidth;
providing an amount of slope adjustment of the downstream bandwidth;
initiating a second mode after competing at least one iteration of the first mode steps, the second mode comprising:
obtaining a high channel modulation and a high channel level for each of a plurality of high frequency channels;
obtaining an average of the high channel levels;
obtaining a low channel modulation and a low channel level for each of a plurality of low frequency channels;
obtaining an average of the low channel levels;
providing an amount of level adjustment of the downstream bandwidth;
providing an amount of slope adjustment of the downstream bandwidth.
obtaining a third difference between the average of the high channel levels and an average of respective high channel goal levels;
obtaining a fourth difference between the average of the low channel levels and an average of respective low channel goal levels;
returning to the first mode when at least one of the third difference and the fourth difference exceeds a respective predetermined threshold; and
directing the removal of the portion of the at least one increment of attenuation when returning to the first mode from the second mode.

13. The method of claim 12 further comprising:
providing the microprocessor with an identification for each of the plurality of high frequency channels and each of the plurality of low frequency channels, the identification indicating whether a respective channel is being transmitted from a supplier,
wherein the average of the high channel levels includes the high channel levels for only those high frequency channels identified as being transmitted from the supplier, and
wherein the average of the low channel levels includes the low channel levels for only those low frequency channels identified as being transmitted from the supplier.
